(19) United States
(12) Patent Application Publication
(10) Pub. No.: US 2014/0286406 A1
(43) Pub. Date: Sep. 25, 2014

(54) METHOD FOR DETERMINING QUANTIZATION PARAMETERS ON BASIS OF SIZE OF CONVERSION BLOCK, AND DEVICE FOR SAME

(71) Applicant: SAMSUNG ELECTRONICS CO., LTD., Suwon-si (KR)

(72) Inventors: Chan-yul Kim, Seongnam-si (KR); Kwang-pyo Choi, Anyang-si (KR); Young-o Park, Seoul (KR)

(73) Assignee: SAMSUNG ELECTRONICS CO., LTD., Suwon-si (KR)

(21) Appl. No.: 14/357,041

(22) PCT Filed: Nov. 8, 2012
(86) PCT No.: PCT/KR2012/009414

§ 371 Date: May 8, 2014

Related U.S. Application Data
(60) Provisional application No. 61/557,091, filed on Nov. 8, 2011.

(51) Int. Cl. H04N 19/126; H04N 19/196

(52) U.S. Cl. CPC H04N 19/00096; H04N 19/00375
USPC 375/240.03

(57) ABSTRACT

Provided are a method and apparatus for determining quantization parameter for a quantization and an inverse quantization performed during a video encoding and decoding. The quantization parameter determination method includes determining transformation units of at least one size included in a coding unit; determining a default quantization parameter of the coding unit; reducing a quantization parameter of a transformation unit that is greater than a predetermined size, to be less than the default quantization parameter; and increasing a quantization parameter of a transformation unit that is less than a predetermined size, to be greater than the default quantization parameter.

### FIELD OF THE INVENTION

The present invention relates to a video encoding and a video decoding, and more particularly, to a quantization method and an inverse quantization method performed during video encoding and video decoding operations.

### DESCRIPTION OF THE RELATED ART

As hardware for reproducing and storing high resolution or high quality video content is being developed and supplied, a need for a video codec for effectively encoding or decoding the high resolution or high quality video content is increasing. According to a conventional video codec, a video is encoded according to a limited encoding method based on a macroblock having a predetermined size.

Image data of a spatial region is transformed into coefficients of a frequency region via frequency transformation. According to a video codec, an image is split into blocks having a predetermined size, discrete cosine transformation (DCT) is performed for each respective block, and frequency coefficients are encoded in block units, for rapid calculation of frequency transformation. Compared with image data of a spatial region, coefficients of a frequency region are easily compressed. In particular, since an image pixel value of a spatial region is expressed according to a prediction error via inter prediction or intra prediction of a video codec, when frequency transformation is performed on the prediction error, a large amount of data may be transformed to 0. According to a video codec, an amount of data may be reduced by replacing data that is consecutively and repeatedly generated with small-sized data.

### SUMMARY OF THE INVENTION

The present invention provides video encoding and decoding, and more particularly, a method of determining a quantization parameter in consideration of image characteristics, for quantization and inverse quantization operations performed during the video encoding and decoding.

According to an aspect of the present invention, there is provided a quantization parameter determination method, the method including: determining transformation units of at least one size included in a coding unit; determining a default quantization parameter of the coding unit; reducing a quantization parameter of a transformation unit that is greater than a predetermined size among the transformation units, to be less than the default quantization parameter; and increasing a quantization parameter of a transformation unit that is less than a predetermined size among the transformation units, to be greater than the default quantization parameter.

### Advantageous Effects

The quantization performed during the video encoding and the video decoding generates the quantization error. According to the video encoding and decoding methods, the size of the transformation unit may vary according to the image characteristic of a region among the transformation units of various sizes. Thus, the quantization parameter is adjusted according to the size of the transformation unit according to the present invention, thereby reducing the quantization error after the video decoding and improving the image quality of the restored image.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a quantization parameter determination apparatus according to an embodiment of the present invention;

FIG. 2 is a flowchart illustrating a method of determining a quantization parameter according to an embodiment of the present invention;

FIG. 3 is a diagram showing a distribution of quantization parameters of transformation units included in a coding unit according to an embodiment of the present invention;

FIG. 4 is a block diagram of a video encoding apparatus including a quantization parameter determination apparatus according to an embodiment of the present invention;

FIG. 5 is a flowchart illustrating a video encoding method accompanied with the quantization parameter determination method according to an embodiment of the present invention;

FIG. 6 is a block diagram of a video decoding apparatus including the quantization parameter determination apparatus according to an embodiment of the present invention;

FIG. 7 is a flowchart illustrating a video decoding method accompanied with the quantization parameter determination method according to an embodiment of the present invention;

FIG. 8 is a block diagram of a video encoding apparatus based on a coding unit according to a tree structure, according to an embodiment of the present invention;

FIG. 9 is a block diagram of a video decoding apparatus based on a coding unit according to a tree structure, according to an embodiment of the present invention;

FIG. 10 is a diagram for describing a concept of coding units according to an embodiment of the present invention;

FIG. 11 is a block diagram of an image encoder based on coding units according to an embodiment of the present invention;

FIG. 12 is a block diagram of an image decoder based on coding units according to an embodiment of the present invention;

FIG. 13 is a diagram illustrating deeper coding units according to depths, and partitions according to an embodiment of the present invention;

FIG. 14 is a diagram for describing a relationship between a coding unit and transformation units, according to an embodiment of the present invention;

FIG. 15 is a diagram for describing encoding information of coding units corresponding to a coded depth, according to an embodiment of the present invention;

FIG. 16 is a diagram of deeper coding units according to depths, according to an embodiment of the present invention;

FIGS. 17 through 19 are diagrams for describing a relationship between coding units, prediction units, and transformation units, according to an embodiment of the present invention;

FIG. 20 is a diagram for describing a relationship between a coding unit, a prediction unit or a partition, and a transformation unit, according to encoding mode information of Table 1;

FIG. 21 illustrates a physical structure of a disc that stores a program, according to an embodiment of the present invention;

FIG. 22 illustrates a disc drive that records and reads a program by using a disc;

FIG. 23 illustrates an entire structure of a content supply system that provides content distribution service;

FIGS. 24 and 25 illustrate external and internal structures of a mobile phone to which a video encoding method and a video decoding method are applied, according to an embodiment of the present invention;

FIG. 26 illustrates a digital broadcasting system employing a communication system, according to an embodiment of the present invention; and

FIG. 27 illustrates a network structure of a cloud computing system using a video encoding apparatus and a video decoding apparatus, according to an embodiment of the present invention.

### DETAILED DESCRIPTION OF THE INVENTION

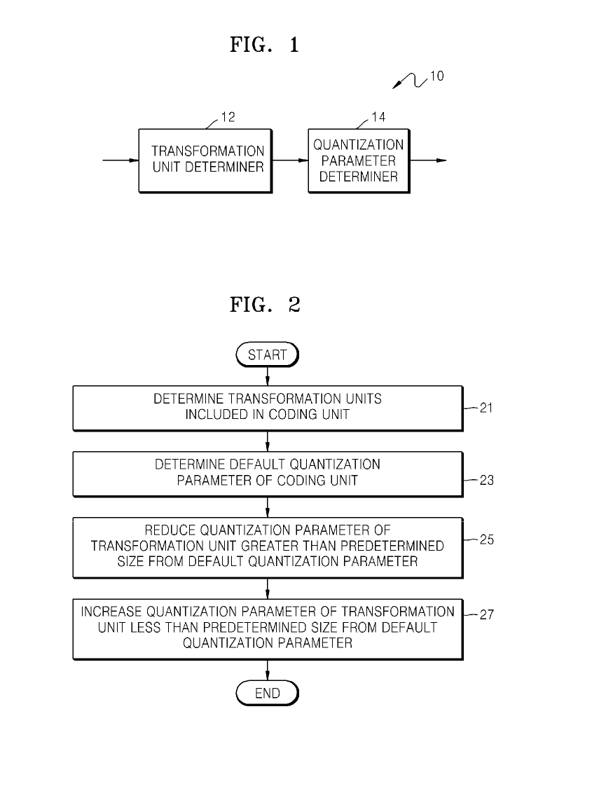

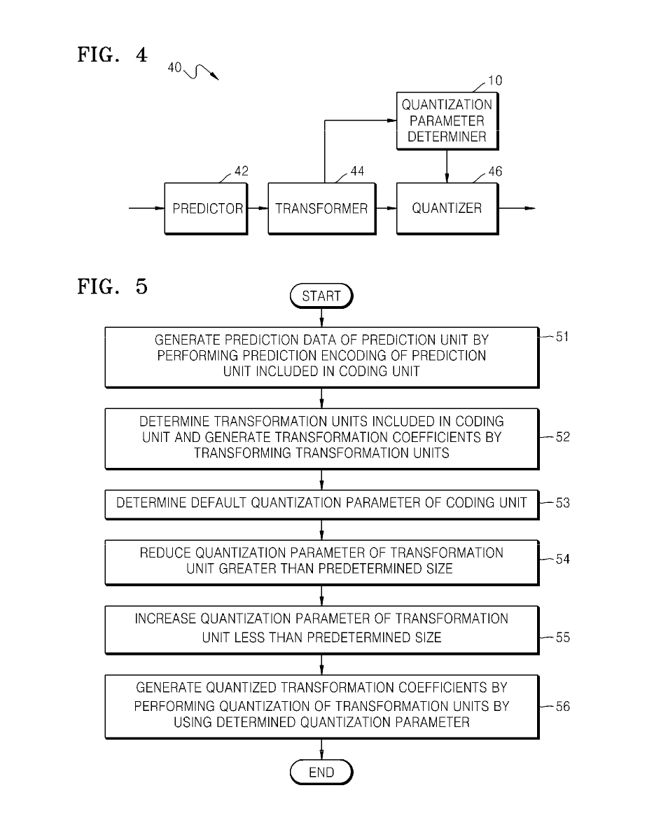

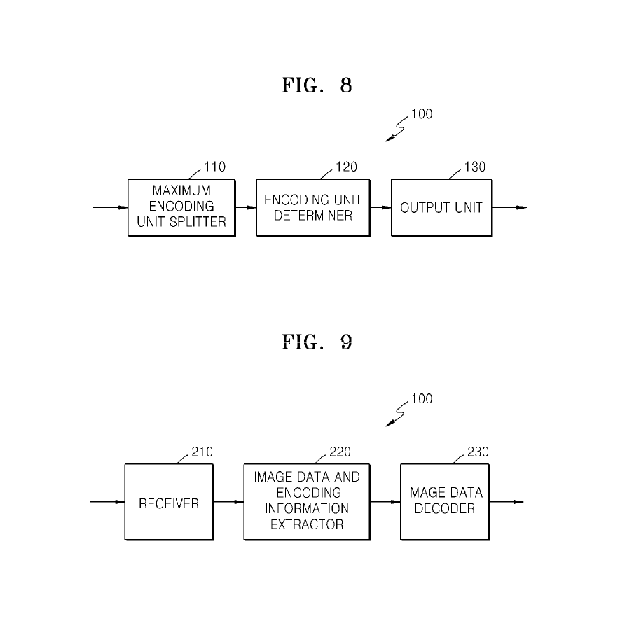

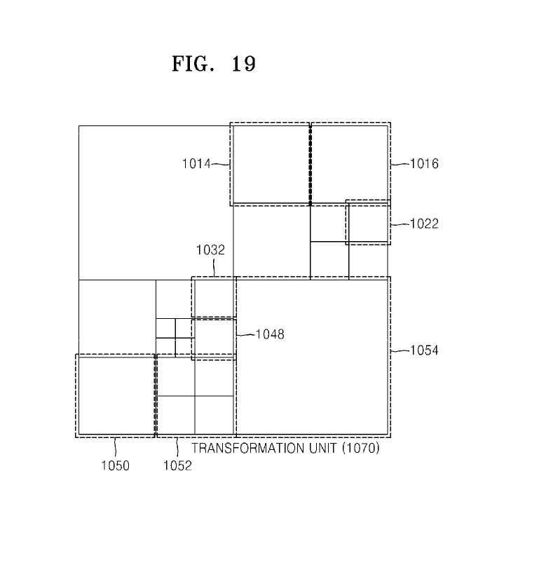

Hereinafter, a quantization parameter determination apparatus and a quantization parameter determination method will be described with reference to FIGS. 1 through 3. In addition, a video encoding apparatus and method, and video decoding apparatus and method accompanied with the quantization parameter determination method will be described with reference to FIGS. 4 through 7. Also, a video encoding method and a video decoding apparatus via the quantization parameter determination method based on a coding unit having a tree structure will be described with reference to FIGS. 8 through 20. Hereinafter, the term ‘image’ may refer to a still image or a moving picture, that is, a video itself.

First, referring to FIGS. 1 through 3, the quantization parameter determination apparatus and the quantization parameter determination method according to an embodiment of the present invention will be described below.

FIG. 1 is a block diagram showing a quantization parameter determination apparatus 10 according to an embodiment of the present invention.

The quantization parameter determination apparatus 10 includes a transformation unit determiner 12 and a quantization parameter determiner 14.

The quantization parameter determination apparatus 10 according to the embodiment of the present invention may perform a quantization or an inverse quantization by a transformation unit in each of image sequences of video. An image according to the embodiment may be divided by maximum coding units, and each of the maximum coding units may be divided into coding units according to tree structure. Each of the coding unit may be encoded through a prediction, a transformation, a quantization, and an entropy encoding operation.

The coding units of the tree structure are consisted of coding units of a hierarchical structure according to a size of the each coding unit. A coding unit of a higher depth is split into coding units of lower depth, and each of the encoding depth of the lower depth is independently determined whether to be split further or not. The depth denotes a number of times the coding unit is spatially split from the maximum coding unit, that is, the uppermost coding unit, to the current coding unit. Therefore, each of the coding units is spatially split from the coding unit of the upper depth, and may independently split from each other.

Each of the coding units may include at least one prediction unit. Intra prediction or motion prediction may be performed with respect to each of the prediction units. As a result of performing the intra prediction or the motion prediction by the prediction unit, prediction data of coding units may be generated.

Each of the coding units may be split into transformation units of tree structures. The transformation units of the tree structure consist of transformation units of a hierarchical structure according to sizes of the transformation units, and a transformation unit of a higher transformation depth is split into four transformation units of a lower transformation depth. Then, it is independently determined whether each of the transformation units of the lower transformation depth will be further split into four pieces. The transformation depth denotes a number of times the transformation unit is split from the maximum transformation unit that has the same size as that of the maximum coding unit, that is, the uppermost transformation unit, to the current coding unit. Therefore, each of the transformation unit may be spatially split from the transformation unit of the upper transformation depth, and independently from each other. The transformation is performed with respect to each of the transformation units so that a transformation coefficient may be determined for each of the transformation units.

Sizes and shapes of the prediction unit and the transformation unit included in the coding unit may be different from each other. The video encoding/decoding methods based on the coding units according to the tree structure, the prediction unit, and the transformation units according to the tree structure will be described below with reference to FIGS. 8 through 20.

A transformation unit determiner 12 according to the embodiment of the present invention determines transformation units having at least one size and included in the current coding unit. The current coding unit may include the transformation units according to the tree structure. Thus, the transformation units of various sizes may be determined.

The quantization parameter determiner 14 according to the embodiment of the present invention may determine quantization parameters of the transformation units determined in the transformation unit determiner 12. The quantization parameter determiner 14 may firstly determine a default quantization parameter of the current coding unit. The default quantization parameter may be a quantization parameter that is basically allocated to all of the transformation units included in the coding unit.

The quantization parameter determiner 14 according to the embodiment of the present invention may adjust the quantization parameter according to the size of the transformation unit.

The quantization parameter determiner 14 may adjust the quantization parameter according to the transformation depth of the transformation unit.

For example, the quantization parameter determiner 14 may reduce a quantization parameter with respect to the transformation unit having a lower transformation depth than a predetermined transformation depth to be less than the default quantization parameter. For example, the quantization parameter determiner 14 may increase a quantization parameter of the transformation unit having a transformation depth that is higher than a predetermined transformation depth to be greater than the default quantization parameter.

The quantization parameter determined by the quantization parameter determiner 14 may be used to perform the quantization or inverse quantization of the transformation unit.

Hereinafter, a method of determining the quantization parameter by a determination apparatus 10 according to an embodiment of the present invention will be described with reference to FIG. 2.

FIG. 2 is a flowchart illustrating the method of determining the quantization parameter according to the embodiment of the present invention.

In operation S21, the transformation unit determiner 12 may determine transformation units of at least one size included in the current coding unit.

In operation S23, the quantization parameter determiner 14 may determine a default quantization parameter of the current coding unit.

In operation S25, the quantization parameter determiner 14 may reduce the quantization parameter of the transformation unit having a size that is greater than a predetermined size to be less than the default quantization parameter.

In operation S27, the quantization parameter determiner 14 may increase a quantization parameter of a transformation unit having a size that is less than a predetermined size to be greater than the default quantization parameter.

In operation S21, the transformation unit determiner 12 may determine transformation units of at least one level of transformation depth included in the coding unit. The transformation depth denotes the number of splits from the transformation unit of the upper transformation depth to the current transformation depth, and thus, the size of the current transformation unit may be determined by a level of the current transformation depth. Therefore, if the transformation unit determiner 12 determines the transformation units of at least one level of transformation depth, the transformation depths of at least one kind of size are determined.

In operation S23, the quantization parameter determiner 14 may determine the default quantization parameter allocated to the transformation unit of a predetermined transformation depth between at least one level of transformation depth.

Also, when the transformation depth gets lower, the corresponding transformation unit gets larger, and when the transformation depth gets higher, the corresponding transformation unit gets smaller. Therefore, in operation S25, the quantization parameter determiner 14 may reduce the quantization parameter of the transformation unit of the transformation depth that is lower than a predetermined transformation depth to be less than the default quantization parameter. Also, in operation S27, the quantization parameter determiner 14 may increase the quantization parameter of the transformation unit having the transformation depth that is greater than the predetermined transformation depth to be greater than the default quantization parameter.

In operation S25, the quantization parameter determiner 16 may reduce the default quantization parameter by a difference value of the quantization parameters. In operation S27, the quantization parameter determiner 16 may increase the default quantization parameter by the difference value of the quantization parameters.

Also, in operation S25, the quantization parameter determiner 16 may determine a reduction amount of the quantization parameter difference value, which is reduced by from the default quantization parameter, in proportional to a reduction amount of the current transformation depth of the current transformation unit of from the predetermined transformation depth. Similarly, in operation S27, the quantization parameter determiner 16 may determine an increase amount of the quantization parameter difference value, which is increased by from the default quantization parameter, in proportional to an increase amount of the current transformation depth of the current transformation unit of from the predetermined transformation depth.

The quantization parameter determination method described in FIG. 2 may be executed by the quantization parameter determination apparatus 10. A processor for executing the quantization parameter determination method according to FIG. 2 is mounted as an internal processor of the quantization parameter determination apparatus 10, or may operate while connecting to the external quantization parameter determination apparatus 10. An internal processor of the quantization parameter determination apparatus 10 may operate as an independent processor, and moreover, a central process unit or a graphic processor of the quantization parameter determination apparatus 10 may operate by including the quantization parameter determination processing module.

The transformation unit determiner 12 of the present embodiment performs transformation by splitting the transformation unit of higher transformation depth from the transformation unit of the uppermost transformation depth, which is the same size as the coding unit 30, in order to determine at least one transformation unit included in the coding unit 30. Also, the transformation unit determiner 12 may perform the split each of the transformation units independently from the other adjacent transformation units. Accordingly, if image characteristics are partially different in the coding unit 30, the transformation unit generating a minimum difference between original data and restored data at every partial region may be independently determined. Therefore, each of the transformation units may be independently determined based on image characteristic of the corresponding region.

The transformation units of the tree structure determined within the coding unit according to the present embodiment may be determined based spatial characteristics of the image. For example, the transformation unit of relatively large size is determined in the static region, and the transformation unit of relatively small size may be determined in the moving region.

In the video encoding and decoding, an inter prediction for predicting or restoring a current prediction unit with reference to other prediction units restored earlier in the image may be performed. The static region is likely to be a region that is referred to for performing the inter prediction of other images. Therefore, in order to improve the performance of the inter prediction of the current prediction unit, the static region that will be the referred region has to be restored with high image quality.

For performing the video encoding, quantization of the transformation coefficients of the image is performed, and an inverse quantization is performed during the video decoding to restore the transformation coefficients of the image. In order to decode the video after encoding the video, the same quantization parameters may be used in the quantization and the inverse quantization processes.

The quantization performed during the video encoding and the video decoding causes a quantization error. Even when the image data is restored by the inverse quantization for decoding the video after the quantization of the original data for the encoding, the restored data is not completely the same as the original data due to the quantization error. Also, as the quantization parameter increases, the quantization error also increases. Therefore, as the quantization parameter is reduced, the encoding error is reduced, and as the quantization parameter is increases, the encoding error may be increased. That is, with respect to the encoded data generated through the encoding of the image, including the quantization, when the restored image is generated by performing the decoding of the encoded data, for example, the inverse quantization, if the quantization parameter is small, the image quality of the restored image is improved, and if the quantization parameter is large, the image quality of the restored image may be degraded.

Therefore, as described above, the static region may be restored with high image quality, and the transformation unit of relatively large size is determined with respect to the static region. Thus, the quantization parameter determination apparatus 10 of the present embodiment allocates a quantization parameter that is relatively small to the transformation unit having relatively large size, and allocates the quantization parameter that is relatively large to the transformation unit having relatively small size.

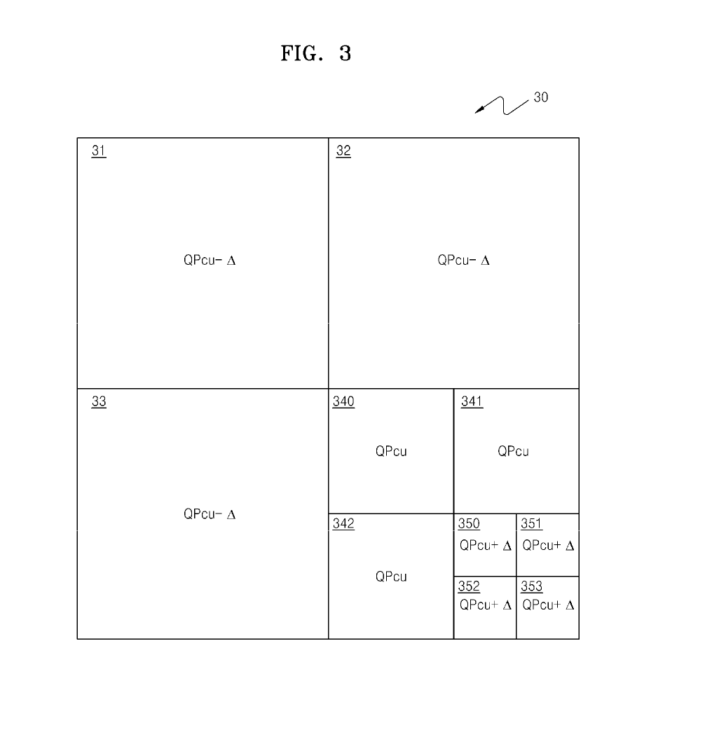

Hereinafter, FIG. 3 shows examples of quantization parameters allocated to the transformation units of the tree structure included in the coding unit by the quantization parameter determination apparatus 10.

FIG. 3 shows a distribution of the quantization parameters of the transformation units included in the coding unit according to the embodiment of the present invention.

The coding unit 30 may be one of the coding units of the tree structure. A size of the coding unit 30 is 64×64, and quantization parameter QPcu with respect to the coding unit 30 is determined.

The quantization parameter determination apparatus 10 may determine the quantization parameter QPcu as a default quantization parameter with respect to the transformation units included in the coding unit 30.

However, the quantization parameter determination apparatus 10 may adjust the quantization parameter according to the size of the transformation units so as to determine the quantization parameters to be different with respect to the transformation units of different sizes.

The coding unit 30 includes transformation units 31, 32, 33, 340, 341, 342, 350, 351, 352, and 353 of tree structure. Transformation units 31, 32, and 33 of transformation depth 1 have sizes of 32×32, transformation units 340, 341, and 342 of transformation depth 2 have sizes of 16×16, transformation units 350, 351, 352, and 353 of transformation depth 3 have sizes of 8×8, and thus, sizes of the transformation units are reduced as the transformation depth gets higher.

The quantization parameter determination apparatus 10 of the present embodiment may allocate the quantization parameter that is relatively small to the large transformation unit, and allocate the quantization parameter that is relatively large to the small transformation unit.

The quantization parameter determination apparatus 10 of the present embodiment may reduce the quantization parameter allocated to the large transformation unit from the default quantization parameter QPcu and may increase the quantization parameter allocated to the small transformation unit from the default quantization parameter QPcu.

As an example, the quantization parameter determination unit 10 may increase or reduce the default quantization parameter QPcu by a variation amount Δ according to the size of the transformation unit. A relation between a size of the transformation unit (TU size) and a variation amount of the quantization parameter (dQP) is shown in following table 11.

TABLE 11

| | | | | |
|---|---|---|---|---|
| TU size | 4 × 4 | 8 × 8 | 16 × 16 | 32 × 32 |
| Implicit dQP | 2 × Δ | Δ | 0 | −Δ |

As shown in Table 11, the quantization parameter determination apparatus 10 allocates the default quantization parameter QPcu to the transformation unit having a size of 16×16, and may increase the quantization parameters to be allocated to the transformation units of 4×4 and 8×8 by 2×Δ and Δ from the default quantization parameter QPcu. When the transformation depth increases by one level and two levels from the transformation unit of 16×16, the transformation unit is reduced to 8×8 and 4×4, and the quantization parameter also increases by Δ and 2×Δ.

Also, the quantization parameter determination apparatus 10 according to the table 11 may reduce the quantization parameter of the transformation unit of a size 32×32 that is greater than the transformation unit of 16×16 by A from the default quantization parameter QPcu.

The quantization parameter determination apparatus 10 may determine the quantization parameter of each of the transformation units as a sum of the default quantization parameter QPcu and a variation amount dQP. Therefore, among the transformation units 31, 32, 33, 340, 341, 342, 350, 351, 352, and 353 of tree structure included in the coding unit 30,

i) a quantization parameter (QPcu−A) is allocated to the transformation units 31, 32, and 33 having a size of 32×32;

ii) a quantization parameter QPcu is allocated to the transformation units 340, 341, and 342 having a size of 16×16; and

iii) a quantization parameter (QPcu+Δ) is allocated to the transformation units 350, 351, 352, and 353 having a size of 8×8.

That is, the largest quantization parameter is determined with respect to the transformation units 350, 351, 352, and 353 having the size of 8×8, and the smallest quantization parameter may be determined with respect to the transformation units 31, 32, and 33 having the largest size 32×32, among the transformation units 31, 32, 33, 340, 341, 342, 350, 351, 352, and 353. In other words, when the transformation depth of the transformation unit is large, the relatively large quantization parameter is allocated to the corresponding transformation unit, and when the transformation depth of the transformation unit is small, the relatively small quantization parameter may be allocated to the corresponding transformation unit.

Therefore, the quantization parameter determination apparatus 10 according to table 11 may reduce the encoding error of the large transformation unit by reducing the quantization error by allocating the small quantization parameter to the large transformation unit. When the encoding error is reduced in the static region, the restoration quality of the video may be improved.

The quantization parameter determination apparatus 10 shown in Table 11 may implicitly determine the variation amount dQP of the quantization parameter as shown in Table 11, according to the size of the transformation unit (implicit dQP). That is, information about the variation amount of the quantization parameter according to the size of the transformation unit, used in the video encoder is set in advance with the video decoder, and the variation amount of the quantization parameter corresponding to the size of the transformation unit may be determined based on the stored information when performing the quantization and the inverse quantization of the video encoder. Also, the variation amount of the quantization parameter corresponding to the size of the transformation unit may be determined based on the information stored in advance, when performing the inverse quantization of the video decoder.

The quantization parameter determination apparatus 10 according to another embodiment may transmit the increase/reduction amount Δ of the variation amount dQP of the quantization parameter used in the quantization of the encoder to the decoder, or may receive the increase/reduction amount Δ of the variation amount dQP of the quantization parameter in the inverse quantization of the decoder.

Also, the quantization parameter determination apparatus 10 according to the embodiment may symmetrically reduce or increase the quantization parameter based on the default quantization parameter, according to the increase or the reduction of the transformation unit. For example, when the size of the transformation unit increases to 8×8, 16×16, and 32×32, the corresponding quantization parameter may symmetrically reduce to QP+Δ, QP, and QP−Δ.

The quantization parameter determination apparatus 10 according to another embodiment may asymmetrically increase or reduce the quantization parameter based on the default quantization parameter, when the size of the transformation unit increases or reduces. For example, when the size of the transformation unit increases to 8×8, 16×16, and 32×32, the corresponding quantization parameter may asymmetrically increase or reduce to QP+Δ, QP, and QP−Δ/2.

The quantization parameter determination apparatus 10 according to another embodiment may exponentially increase or reduce the quantization parameter based on the default quantization parameter, according to the increase or reduction of the transformation unit. For example, the variation amount of the quantization parameter may be N̂Δ.

Also, the quantization parameter determination apparatus 10 may adjust the quantization parameter according to the size of the transformation units, with respect to the transformation units of luma components and chroma components.

The quantization parameter determination apparatus 10 according to another embodiment may adjust the quantization parameter according to the size of the transformation units, with respect to the transformation units of luma components.

Also, the quantization parameter determination apparatus 10 of the embodiment may reduce the quantization parameter of the transformation unit having a transformation depth that is lower than a predetermined transformation depth, to be less than the default quantization parameter, and may increase the quantization parameter of the transformation unit having a transformation depth that is greater than the predetermined depth, to be greater than the default quantization parameter.

If a level of the transformation depth corresponds to the size of the transformation unit, the quantization parameter of the transformation unit that is larger than a predetermined size is reduced less than the default quantization parameter. In addition, the quantization parameter of the transformation unit that is smaller than a predetermined size may be increased to be greater than the default quantization parameter.

However, in the quantization parameter determination apparatus 10 according to another embodiment, the level of the transformation depth may indicate whether the transformation unit is split into the transformation units of the same size, not the size of the transformation unit. In this case, the quantization parameter determination apparatus 10 may reduce the quantization parameter of the transformation unit having the transformation depth that is lower than a predetermined depth to be less than the default quantization parameter and increase the quantization parameter of the transformation unit having the transformation depth that is higher than the predetermined depth to be greater than the default quantization parameter, in consideration of the transformation depth only, not the size of the transformation unit.

Hereinafter, a video encoding apparatus and method and a video decoding apparatus and method including the quantization parameter determination apparatus 10 according to the embodiment of the present invention will be described below with reference to FIGS. 4 through 7.

FIG. 4 is a block diagram of a video encoding apparatus 40 including the quantization parameter determination apparatus 10 according to an embodiment of the present invention.

The video encoding apparatus 40 includes a predictor 42, a transformer 44, the quantization parameter determination apparatus 10, and a quantizer 46.

The predictor 42 may perform may perform intra prediction or motion prediction at least on a prediction unit in the current coding unit. The transformer 44 of the present embodiment may determine transformation units of tree structure, which are to be transformed, in the current coding unit.

The transformer 44 of the present embodiment may perform the transformation of the transformation units included in the current coding unit. The quantizer 46 of the present embodiment may perform the quantization of the transformation coefficients of the transformation units.

The quantization parameter determination apparatus 10 of the present embodiment may determine the quantization parameter of the transformation units. The quantization parameter may be increased or reduced according to the sizes of the transformation units.

Detailed operations of the video encoding apparatus 40 of FIG. 4 will be described with reference to a flowchart of FIG. 5.

FIG. 5 is a flowchart illustrating a video encoding method including the quantization parameter determination method according to an embodiment of the present invention.

In operation 51, the predictor 42 may perform the intra prediction or the motion prediction of the at least one prediction unit in the current coding unit to generate prediction data of each prediction unit. The prediction data of the prediction unit generated as a result of the motion prediction may be residual data between the current prediction unit and a reference prediction unit.

In operation 52, the transformer 44 may determine the transformation units of tree structure to be transformed, with respect to the current coding unit including the prediction data generated by the predictor 42. The transformer 44 may generate transformation coefficients of the transformation units by performing the transforming of the transformation units included in the current coding unit.

In operation 53, the quantization parameter determination apparatus 10 may determine a default quantization parameter of the coding unit.

The quantization parameter determination apparatus 10 may adjust the quantization parameters of the transformation units according to the sizes of the transformation units. In operation 54, the quantization parameter determination apparatus 10 may reduce the quantization parameter of the transformation unit that is greater than a predetermined size, to be less than the default quantization parameter. In operation 55, the quantization parameter determination apparatus 10 may increase the quantization parameter of the transformation unit that is less than a predetermined size, to be greater than the default quantization parameter.

The quantization parameter determination apparatus 10 may increase a reduction amount of the quantization parameter in proportion to the increase amount of the transformation unit size. Similarly, the quantization parameter determination apparatus 10 may increase an increase amount of the quantization parameter in proportion to the reduction amount of the transformation unit size.

Also, the quantization parameter determination apparatus 10 may adjust the quantization parameter according to transformation depths of the transformation units. In operation 53, the quantization parameter determination apparatus 10 may reduce the quantization parameter of the transformation unit having a transformation depth that is lower than a predetermined depth, to be less than the default quantization parameter. In operation 54, the quantization parameter determination apparatus 10 may increase the quantization parameter of the transformation unit having a transformation depth that is higher than a predetermined depth, to be greater than the default quantization parameter.

The quantization parameter determination apparatus 10 may increase the reduction amount of the quantization parameter in proportion to the reduction amount of the transformation depth. Similarly, the quantization parameter determination apparatus 10 may increase the increase amount of the quantization parameter in proportion to the increase amount of the transformation depth.

Detailed operations of the quantization parameter determination apparatus 10 included in the video encoding apparatus 40 are the same as the operations described with reference to FIGS. 1 through 3.

In operation 56, the quantizer 46 may perform the quantization of the transformation coefficients of the transformation units generated by the transformer 44 by using the quantization parameters determined by the quantization parameter determination apparatus 10. As a result of the quantization, quantized transformation coefficients may be generated.

The video encoding apparatus 40 of the present embodiment may encode and transmit information about a difference value of the quantization parameter determined by the quantization parameter determination apparatus 10 increased/reduced by from the default quantization parameter, and the default quantization parameter.

Also, operations of encoding the current coding unit by the video encoding apparatus 40 are described with reference to FIGS. 4 and 5. The above described operations described with reference to FIGS. 4 and 5 may be performed on all coding units of the tree structure, including the current coding unit. Also, the above described encoding operations described with reference to FIGS. 4 and 5 are performed with respect to each of the current maximum coding unit including the coding units of the tree structure including the current coding unit, and each of a plurality of maximum coding units in the current image, so as to encode the current image.

The video encoding method of FIG. 5 may be realized by the video encoding apparatus 40. An encoding processor realizing the video encoding method of FIG. 5 may be mounted in the video encoding apparatus 40 as an internal processor, or may operate in connection with the external video encoding apparatus 40. The internal processor of the video encoding apparatus 40 of the present embodiment may operate as a video encoding processing module included in a central processing unit or a graphic processing unit, as well as an independent processor.

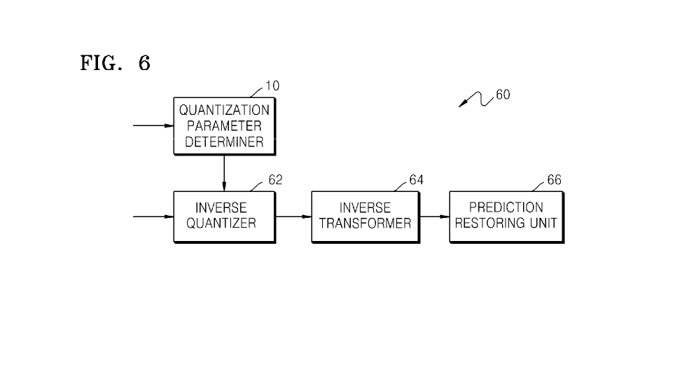

FIG. 6 is a block diagram of a video decoding apparatus 60 including the quantization parameter determination apparatus 10 according to an embodiment of the present invention.

The video decoding apparatus 60 includes the quantization parameter determination apparatus 10, an inverse quantizer 62, an inverse transformer 64, and a prediction restoring unit 66.

The quantization parameter determination apparatus 10 of the present embodiment determines the transformation units of at least one size included in the coding unit, and determines the quantization parameters according to the size of the transformation units.

The inverse quantizer 62 of the present embodiment performs the inverse quantization of the transformation units.

The inverse transformer 64 performs the inverse transformation of the transformation coefficients.

The prediction restoring unit 66 of the present embodiment performs the intra prediction or the motion compensation of at least one prediction unit in the current coding unit.

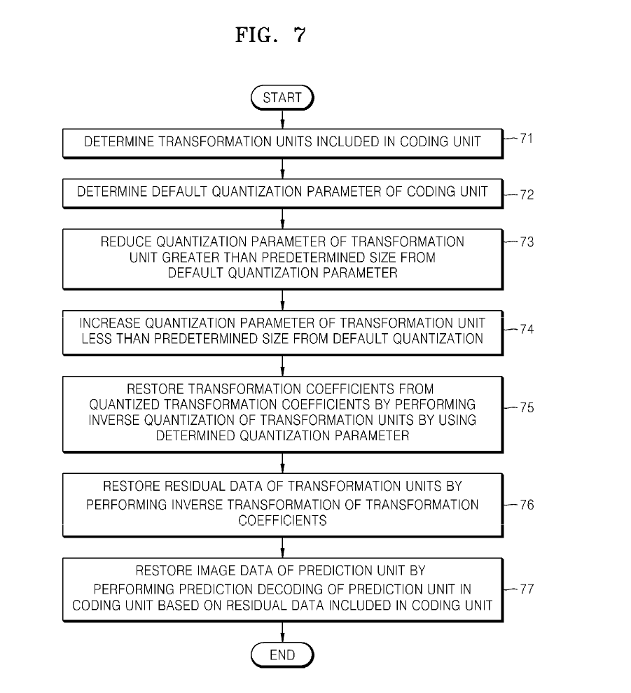

Detailed operations of the video decoding apparatus 60 of FIG. 6 will be described with reference to a flowchart of FIG. 7.

FIG. 7 is a flowchart illustrating a video decoding method including the quantization parameter determination method according to an embodiment of the present invention.

In operation 71, the quantization parameter determination apparatus 10 determines transformation units of at least one size included in the current coding unit.

In operation 72, the quantization parameter determination apparatus 10 determines a default quantization parameter of the current coding unit. The default quantization parameter of the current coding unit may be extracted from a CU header in which information about the current coding unit is carried.

The quantization parameter determination apparatus 10 may adjust the quantization parameter according to the size of the transformation units. In operation 73, the quantization parameter determination apparatus 10 may reduce the quantization parameter of the transformation unit that is greater than a predetermined size, to be less than the default quantization parameter. In operation 74, the quantization parameter determination apparatus 10 may increase the quantization parameter of the transformation unit having a size less than a predetermined size to be greater than the default quantization parameter.

The quantization parameter determination apparatus 10 may increase the reduction amount of the quantization parameter in proportion to the increase amount of the transformation unit size. Similarly, the quantization parameter determination apparatus 10 may increase the increase amount of the quantization parameter in proportion to the reduction amount of the transformation unit size.

Also, the quantization parameter determination apparatus 10 may adjust the quantization parameter according to transformation depths of the transformation units. In operation 73, the quantization parameter determination apparatus 10 may reduce the quantization parameter of the transformation unit having a transformation depth that is lower than a predetermined depth, to be less than the default quantization parameter. In operation 74, the quantization parameter determination apparatus 10 may increase the quantization parameter of the transformation unit having a transformation depth that is greater than a predetermined depth, to be greater than the default quantization parameter.

The quantization parameter determination apparatus 10 may increase the reduction amount of the quantization parameter in proportion to the reduction amount of the transformation depth. Similarly, the quantization parameter determination apparatus 10 may increase the increase amount of the quantization parameter in proportion to the increase amount of the transformation depth.

Detailed operations of the quantization parameter determination apparatus 10 included in the video decoding apparatus 60 are the same as the operations described with reference to FIGS. 1 through 3.

In operation 75, the inverse quantizer 62 may perform the inverse quantization of the transformation units by using the quantization parameters of the transformation units determined by the quantization parameter determination apparatus 10. The transformation coefficients may be restored from the quantized transformation coefficients through the inverse quantization.

In operation 76, the inverse transformer 64 may perform the inverse transformation of the transformation coefficients restored by the inverse quantizer 62 to restore the prediction data.

In operation 77, the prediction restoring unit 66 may perform an intra prediction or the motion compensation with respect to at least one prediction unit of the current coding unit, based on the prediction data that is restored by the inverse transformer 64 and included in the current coding unit. The prediction restoring unit 66 may restore the image data of each prediction unit through the intra prediction or the motion compensation. Since the image data is restored for each of the prediction units, the image data of the current coding unit can be restored.

In operation 71, the quantization parameter determination apparatus 10 may receive information about the difference value of the quantization parameter increasing/reducing from the default quantization parameter, together with the default quantization parameter of the current coding unit. The quantization parameter determination apparatus 10 may determine the quantization parameters according to the size of the transformation units, by using the received default quantization parameter and the information about the difference value of the quantization parameter.

Also, operations of decoding the current coding unit by the video decoding apparatus 60 are described with reference to FIGS. 6 and 7. The above described operations described with reference to FIGS. 6 and 7 may be performed on all coding units of the tree structure, including the current coding unit. Also, the above described decoding operations described with reference to FIGS. 6 and 7 are performed with respect to each of the current maximum coding unit including the coding units of the tree structure including the current coding unit, and each of a plurality of maximum coding units in the current image, so as to restore the current image.

Accordingly, the video decoding apparatus 60 may restore the video including image sequences, when the images are restored.

The video decoding method of FIG. 7 may be realized by the video decoding apparatus 60. A decoding processor realizing the video decoding method of FIG. 7 may be mounted in the video decoding apparatus 60 as an internal processor, or may operate in connection with the external video decoding apparatus 60. The internal processor of the video decoding apparatus 60 of the present embodiment may operate as a video decoding processing module included in a central processing unit or a graphic processing unit, as well as an independent processor.

As described above, in the quantization parameter determination apparatus 10, the blocks obtained by splitting video data are split into coding units of tree structure, and the transformation units for transforming and quantizing the coding units are used. Hereinafter, a video encoding method and apparatus, and video decoding method and apparatus based on the coding units and transformation units of the tree structure according to embodiments of the present invention will be described below with reference to FIGS. 8 through 20.

FIG. 8 is a block diagram of a video encoding apparatus 100 based on a coding unit according to a tree structure, according to an embodiment of the present invention.

The video encoding apparatus 100 via video prediction based on a coding unit according to a tree structure includes a maximum coding unit splitter 110, a coding unit determiner 120, and an output unit 130. Hereinafter, for convenience of description, the video encoding apparatus 100 via video prediction based on a coding unit according to a tree structure is referred to as ‘the video encoding apparatus 100’.

The maximum coding unit splitter 110 may split a current picture based on a maximum coding unit for the current picture of an image. If the current picture is larger than the maximum coding unit, image data of the current picture may be split into the at least one maximum coding unit. The maximum coding unit according to an embodiment of the present invention may be a data unit having a size of 32×32, 64×64, 128×128, 256×256, etc., wherein a shape of the data unit is a square having a width and length in squares of 2. The image data may be output to the coding unit determiner 120 according to the at least one maximum coding unit.

A coding unit according to an embodiment of the present invention may be characterized by a maximum size and a depth. The depth denotes a number of times the coding unit is spatially split from the maximum coding unit, and as the depth deepens, deeper encoding units according to depths may be split from the maximum coding unit to a minimum coding unit. A depth of the maximum coding unit is an uppermost depth and a depth of the minimum coding unit is a lowermost depth. Since a size of a coding unit corresponding to each depth decreases as the depth of the maximum coding unit deepens, a coding unit corresponding to an upper depth may include a plurality of coding units corresponding to lower depths.

As described above, the image data of the current picture is split into the maximum coding units according to a maximum size of the coding unit, and each of the maximum coding units may include deeper coding units that are split according to depths. Since the maximum coding unit according to an embodiment of the present invention is split according to depths, the image data of a spatial domain included in the maximum coding unit may be hierarchically classified according to depths.

A maximum depth and a maximum size of a coding unit, which limit the total number of times a height and a width of the maximum coding unit are hierarchically split may be predetermined.

The coding unit determiner 120 encodes at least one split region obtained by splitting a region of the maximum coding unit according to depths, and determines a depth to output a finally encoded image data according to the at least one split region. In other words, the coding unit determiner 120 determines a coded depth by encoding the image data in the deeper coding units according to depths, according to the maximum coding unit of the current picture, and selecting a depth having the least encoding error. The determined coded depth and the encoded image data according to the determined coded depth are output to the output unit 130.

The image data in the maximum coding unit is encoded based on the deeper coding units corresponding to at least one depth equal to or below the maximum depth, and results of encoding the image data are compared based on each of the deeper coding units. A depth having the least encoding error may be selected after comparing encoding errors of the deeper coding units. At least one coded depth may be selected for each maximum coding unit.

The size of the maximum coding unit is split as a coding unit is hierarchically split according to depths, and as the number of coding units increases. Also, even if coding units correspond to the same depth in one maximum coding unit, it is determined whether to split each of the coding units corresponding to the same depth to a lower depth by measuring an encoding error of the image data of the each coding unit, separately. Accordingly, even when image data is included in one maximum coding unit, the image data is split into regions according to the depths and the encoding errors may differ according to regions in the one maximum coding unit, and thus the coded depths may differ according to regions in the image data. Thus, one or more coded depths may be determined in one maximum coding unit, and the image data of the maximum coding unit may be divided according to coding units of at least one coded depth.

Accordingly, the coding unit determiner 120 may determine coding units having a tree structure included in the maximum coding unit. The ‘coding units having a tree structure’ according to an embodiment of the present invention include coding units corresponding to a depth determined to be the coded depth, from among all deeper coding units included in the maximum coding unit. A coding unit of a coded depth may be hierarchically determined according to depths in the same region of the maximum coding unit, and may be independently determined in different regions. Similarly, a coded depth in a current region may be independently determined from a coded depth in another region.

A maximum depth according to an embodiment of the present invention is an index related to the number of times splitting is performed from a maximum coding unit to a minimum coding unit. A first maximum depth according to an embodiment of the present invention may denote the total number of times splitting is performed from the maximum coding unit to the minimum coding unit. A second maximum depth according to an embodiment of the present invention may denote the total number of depth levels from the maximum coding unit to the minimum coding unit. For example, when a depth of the maximum coding unit is 0, a depth of a coding unit, in which the maximum coding unit is split once, may be set to 1, and a depth of a coding unit, in which the maximum coding unit is split twice, may be set to 2. Here, if the minimum coding unit is a coding unit in which the maximum coding unit is split four times, 5 depth levels of depths 0, 1, 2, 3 and 4 exist, and thus the first maximum depth may be set to 4, and the second maximum depth may be set to 5.

Prediction encoding and transformation may be performed according to the maximum coding unit. The prediction encoding and the transformation are also performed based on the deeper coding units according to a depth equal to or depths lower than the maximum depth, according to the maximum coding unit.

Since the number of deeper coding units increases whenever the maximum coding unit is split according to depths, encoding including the prediction encoding and the transformation is performed on all of the deeper coding units generated as the depth deepens. For convenience of description, the prediction encoding and the transformation will now be described based on a coding unit of a current depth, in a maximum coding unit.

The video encoding apparatus 100 may variously select a size or shape of a data unit for encoding the image data. In order to encode the image data, operations, such as prediction encoding, transformation, and entropy encoding, are performed, and at this time, the same data unit may be used for all operations or different data units may be used for each operation.

For example, the video encoding apparatus 100 may select not only a coding unit for encoding the image data, but also a data unit different from the coding unit so as to perform the prediction encoding on the image data in the coding unit.

In order to perform prediction encoding on the maximum coding unit, the prediction encoding may be performed based on a coding unit corresponding to a coded depth, i.e., based on a coding unit that is no longer split into coding units corresponding to a lower depth. Hereinafter, the coding unit that is no longer split and becomes a basis unit for prediction encoding will now be referred to as a ‘prediction unit’. A partition obtained by splitting the prediction unit may include a prediction unit or a data unit obtained by splitting at least one of a height and a width of the prediction unit. The partition is a data unit obtained by dividing the prediction unit of the coding unit and the prediction unit may be a partition having the same size as the coding unit.

For example, when a coding unit of 2N×2N (where N is a positive integer) is no longer split and becomes a prediction unit of 2N×2N, a size of a partition may be 2N×2N, 2N×N, N×2N, or N×N. Examples of a partition type include symmetrical partitions that are obtained by symmetrically splitting a height or width of the prediction unit, partitions obtained by asymmetrically splitting the height or width of the prediction unit, such as 1:n or n:1, partitions that are obtained by geometrically splitting the prediction unit, and partitions having arbitrary shapes.

A prediction mode of the prediction unit may be at least one of an intra mode, a inter mode, and a skip mode. For example, the intra mode or the inter mode may be performed on the partition of 2N×2N, 2N×N, N×2N, or N×N. Also, the skip mode may be performed only on the partition of 2N×2N. The encoding is independently performed on one prediction unit in a coding unit, thereby selecting a prediction mode having a least encoding error.

The video encoding apparatus 100 may also perform the transformation on the image data in a coding unit based not only on the coding unit for encoding the image data, but also based on a transformation unit that is different from the coding unit. In order to perform the transformation in the coding unit, the transformation may be performed based on a data unit having a size smaller than or equal to the coding unit. For example, the transformation unit for the transformation may include a transformation unit for an intra mode and a data unit for an inter mode.

Similarly to the coding unit according to the tree structure according to the present embodiment, the transformation unit in the coding unit may be recursively split into smaller sized regions and residual data in the coding unit may be divided according to the transformation having the tree structure according to transformation depths.

According to an embodiment of the present invention, a transformation depth indicating the number of times splitting is performed to reach the transformation unit by splitting the height and width of the coding unit may also be set in the transformation unit. For example, when the size of a transformation unit of a current coding unit is 2N×2N, a transformation depth may be set to 0. When the size of a transformation unit is N×N, the transformation depth may be set to 1. In addition, when the size of the transformation unit is N/2×N/2, the transformation depth may be set to 2. That is, the transformation unit according to the tree structure may also be set according to the transformation depth.

Encoding information according to coding units corresponding to a coded depth requires not only information about the coded depth, but also about information related to prediction encoding and transformation. Accordingly, the coding unit determiner 120 not only determines a coded depth having a least encoding error, but also determines a partition type in a prediction unit, a prediction mode according to prediction units, and a size of a transformation unit for transformation.

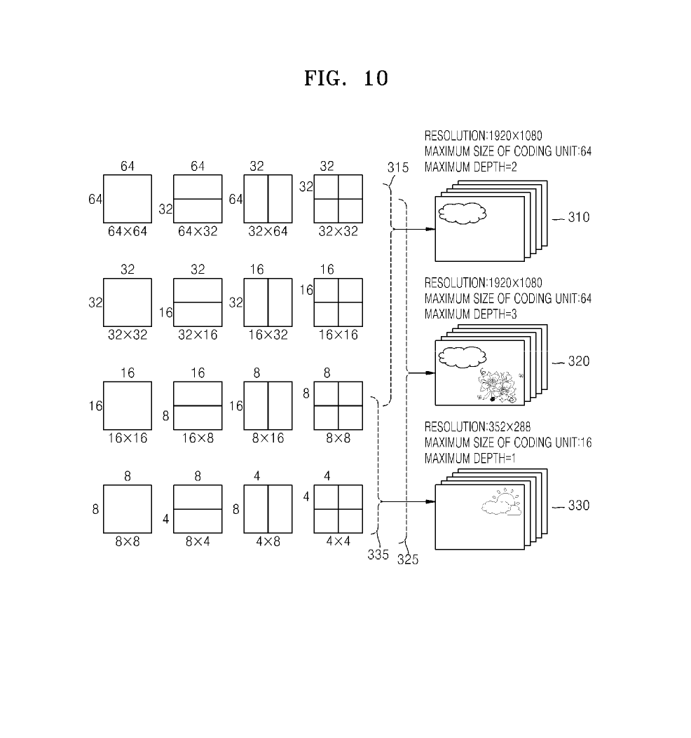

Coding units and a prediction unit/partition according to a tree structure in a maximum coding unit, and a method of determining a transformation unit, according to embodiments of the present invention, will be described in detail later with reference to FIGS. 10 through 21.

The coding unit determiner 120 may measure an encoding error of deeper coding units according to depths by using Rate-Distortion Optimization based on Lagrangian multipliers.

The output unit 130 outputs the image data of the maximum coding unit, which is encoded based on the at least one coded depth determined by the coding unit determiner 120, and information about the encoding mode according to the coded depth, in bitstreams.

The encoded image data may be obtained by encoding residual data of an image.

The information about the encoding mode according to the coded depth may include information about the coded depth, the partition type in the prediction unit, the prediction mode, and the size of the transformation unit.

The information about the coded depth may be defined by using split information according to depths, which indicates whether encoding is performed on coding units of a lower depth instead of a current depth. If the current depth of the current coding unit is the coded depth, image data in the current coding unit is encoded and output, and thus the split information may be defined not to split the current coding unit to a lower depth. Alternatively, if the current depth of the current coding unit is not the coded depth, the encoding is performed on the coding unit of the lower depth, and thus the split information may be defined to split the current coding unit to obtain the coding units of the lower depth.

If the current depth is not the coded depth, encoding is performed on the coding unit that is split into the coding unit of the lower depth. Since at least one coding unit of the lower depth exists in one coding unit of the current depth, the encoding is repeatedly performed on each coding unit of the lower depth, and thus the encoding may be recursively performed for the coding units having the same depth.

Since the coding units having a tree structure are determined for one maximum coding unit, and information about at least one encoding mode is determined for a coding unit of a coded depth, information about at least one encoding mode may be determined for one maximum coding unit. Also, a coded depth of the image data of the maximum coding unit may be different according to locations since the image data is hierarchically split according to depths, and thus information about the coded depth and the encoding mode may be set for the image data.

Accordingly, the output unit 130 may assign encoding information about a corresponding coded depth and an encoding mode to at least one of the coding unit, the prediction unit, and a minimum unit included in the maximum coding unit.

The minimum unit according to an embodiment of the present invention is a rectangular data unit obtained by splitting the minimum coding unit constituting the lowermost depth by 4. Alternatively, the minimum unit may be a maximum rectangular data unit having a maximum size, which is included in all of the coding units, prediction units, partition units, and transformation units included in the maximum coding unit.

For example, the encoding information output through the output unit 130 may be classified into encoding information according to coding units, and encoding information according to prediction units. The encoding information according to the coding units may include the information about the prediction mode and about the size of the partitions. The encoding information according to the prediction units may include information about an estimated direction of an inter mode, about a reference image index of the inter mode, about a motion vector, about a chroma component of an intra mode, and about an interpolation method of the intra mode.

Also, information about a maximum size of the coding unit defined according to pictures, slices, or GOPs, and information about a maximum depth may be inserted into a header of a bitstream, a SPS (Sequence Parameter Set) or a picture parameter set (PPS).

In addition, information about a maximum size of a transformation unit and information about a minimum size of a transformation, which are acceptable for a current video may also be output via a header of a bitstream, a SPS or a PPS. The output unit 130 may encode and output reference information, prediction information, single-direction prediction information, and information about a slice type including a fourth slice type, which are related to prediction described with reference to FIGS. 1 through 8.

In the video encoding apparatus 100, the deeper coding unit may be a coding unit obtained by dividing a height or width of a coding unit of an upper depth, which is one layer above, by two. In other words, when the size of the coding unit of the current depth is 2N×2N, the size of the coding unit of the lower depth is N×N. Also, the coding unit of the current depth having the size of 2N×2N may include a maximum value 4 of the coding unit of the lower depth.

Accordingly, the video encoding apparatus 100 may form the coding units having the tree structure by determining coding units having an optimum shape and an optimum size for each maximum coding unit, based on the size of the maximum coding unit and the maximum depth determined considering characteristics of the current picture. Also, since encoding may be performed on each maximum coding unit by using any one of various prediction modes and transformations, an optimum encoding mode may be determined considering characteristics of the coding unit of various image sizes.

Thus, if an image having high resolution or large data amount is encoded in a conventional macroblock, a number of macroblocks per picture excessively increases. Accordingly, a number of pieces of compressed information generated for each macroblock increases, and thus it is difficult to transmit the compressed information and data compression efficiency decreases. However, by using the video encoding apparatus 100, image compression efficiency may be increased since a coding unit is adjusted while considering characteristics of an image while increasing a maximum size of a coding unit while considering a size of the image.

The video encoding apparatus 100 of FIG. 8 may perform the operation of the quantization parameter determination apparatus 10 and the video encoding apparatus 40 as described with reference to FIG. 1.

The coding unit determiner 120 may perform a transformation and a quantization for each maximum coding unit, in coding units according to a tree structure.

The coding unit determiner 120 determines a default quantization parameter of the current coding unit.

The coding unit determiner 120 may adjust the quantization parameter according to the size of the transformation units. The coding unit determiner 120 may reduce the quantization parameter of the transformation unit that is greater than a predetermined size to be less than the default quantization parameter. The coding unit determiner 120 may increase the quantization parameter of the transformation unit that is less than the predetermined size to be greater than the default quantization parameter.

In particular, the coding unit determiner 120 may increase a reduction amount of the quantization parameter in proportion to an increasing amount of the transformation unit size. Similarly, the increasing amount of the quantization parameter may increase in proportion to the reduction amount of the transformation unit size.

As another example, the coding unit determiner 120 may adjust the size of the transformation unit according to the transformation depth of the transformation units. The coding unit determiner 120 may reduce the quantization parameter of the transformation unit having a transformation depth that is lower than a predetermined depth, to be less than the default quantization parameter. The coding unit determiner 120 may increase the quantization parameter of the transformation unit having a transformation depth that is higher than a predetermined depth, to be greater than the default quantization parameter.

In this case, the coding unit determiner 120 may increase the reduction amount of the quantization parameter in proportion to the reduction amount of the transformation depth. Similarly, the coding unit determiner 120 may increase the increase amount of the quantization parameter in proportion to the increase amount of the transformation depth.

The coding unit determiner 120 may perform the quantization of the transformation coefficients of the transformation units by using the quantization parameter determined according to the size of the transformation unit or the transformation depth, and may generate quantized transformation coefficients. Also, the coding unit determiner 120 may restore the transformation coefficients by performing the inverse quantization of the quantized transformation coefficients by using the quantization parameter determined according to the size of the transformation unit or the transformation depth, during the decoding operation for generating a reference image for the inter prediction.

Information about the reduction amount/increase amount of the quantization parameter corresponding to the size of the transformation unit or the transformation depth may be determined in advance between the video encoding apparatus 100 and a video decoding apparatus 200 that will be described below with reference to FIG. 9. However, if the information is not determined in advance, the video encoding apparatus 100 may encode the information about the variation amount of the quantization parameter corresponding to the size of the transformation unit or the transformation depth, and outputs the information.

The information about the variation amount of the quantization parameter corresponding to the size of the transformation unit or the transformation depth may be set for every sequence, every picture, or every slice. In this case, the information about the variation amount of the quantization parameter corresponding to the size of the transformation unit or the transformation depth may be inserted into a SPS (Sequence Parameter Set), a picture parameter set (PPS), or a slice header.

FIG. 9 is a block diagram of a video decoding apparatus 200 based on a coding unit according to a tree structure, according to an embodiment of the present invention.

The video decoding apparatus 200 based on the coding unit according to the tree structure includes a receiver 210, an image data and encoding information extractor 220, and an image data decoder 230. Hereinafter, for convenience of description, the video decoding apparatus 200 using video prediction based on a coding unit according to a tree structure will be referred to as the ‘video decoding apparatus 200’.

Definitions of various terms, such as a coding unit, a depth, a prediction unit, a transformation unit, and information about various encoding modes, for decoding operations of the video decoding apparatus 200 are identical to those described with reference to FIG. 8 and the video encoding apparatus 100.

The receiver 210 receives and parses a bitstream of an encoded video. The image data and encoding information extractor 220 extracts encoded image data for each coding unit from the parsed bitstream, wherein the coding units have a tree structure according to each maximum coding unit, and outputs the extracted image data to the image data decoder 230. The image data and encoding information extractor 220 may extract information about a maximum size of a coding unit of a current picture, from a header about the current picture, a SPS, or a PPS.

Also, the image data and encoding information extractor 220 extracts information about a coded depth and an encoding mode for the coding units having a tree structure according to each maximum coding unit, from the parsed bitstream. The extracted information about the coded depth and the encoding mode is output to the image data decoder 230. In other words, the image data in a bit stream is split into the maximum coding unit so that the image data decoder 230 decodes the image data for each maximum coding unit.

The information about the coded depth and the encoding mode according to the maximum coding unit may be set for information about at least one coding unit corresponding to the coded depth, and information about an encoding mode may include information about a partition type of a corresponding coding unit corresponding to the coded depth, about a prediction mode, and a size of a transformation unit. Also, splitting information according to depths may be extracted as the information about the coded depth.

The information about the coded depth and the encoding mode according to each maximum coding unit extracted by the image data and encoding information extractor 220 is information about a coded depth and an encoding mode determined to generate a minimum encoding error when an encoder, such as the video encoding apparatus 100, repeatedly performs encoding for each deeper coding unit according to depths according to each maximum coding unit. Accordingly, the video decoding apparatus 200 may restore an image by decoding the image data according to a coded depth and an encoding mode that generates the minimum encoding error.

Since encoding information about the coded depth and the encoding mode may be assigned to a predetermined data unit from among a corresponding coding unit, a prediction unit, and a minimum unit, the image data and encoding information extractor 220 may extract the information about the coded depth and the encoding mode according to the predetermined data units. The predetermined data units to which the same information about the coded depth and the encoding mode is assigned may be inferred to be the data units included in the same maximum coding unit.

The image data decoder 230 restores the current picture by decoding the image data in each maximum coding unit based on the information about the coded depth and the encoding mode according to the maximum coding units. In other words, the image data decoder 230 may decode the encoded image data based on the extracted information about the partition type, the prediction mode, and the transformation unit for each coding unit from among the coding units having the tree structure included in each maximum coding unit. A decoding process may include prediction including intra prediction and motion compensation, and inverse transformation.

The image data decoder 230 may perform intra prediction or motion compensation according to a partition and a prediction mode of each coding unit, based on the information about the partition type and the prediction mode of the prediction unit of the coding unit according to coded depths.

In addition, the image data decoder 230 may read transformation unit information according to a tree structure for each coding unit so as to determine transform units for each coding unit and perform inverse transformation based on a transformation units for each coding unit, for inverse transformation for each maximum coding unit. Via the inverse transformation, a pixel value of a spatial region of the coding unit may be restored.

The image data decoder 230 may determine at least one coded depth of a current maximum coding unit by using split information according to depths. If the split information indicates that image data is no longer split in the current depth, the current depth is a coded depth. Accordingly, the image data decoder 230 may decode encoded data of at least one coding unit corresponding to each coded depth in the current maximum coding unit by using the information about the partition type of the prediction unit, the prediction mode, and the size of the transformation unit.

In other words, data units containing the encoding information including the same split information may be gathered by observing the encoding information set assigned for the predetermined data unit from among the coding unit, the prediction unit, and the minimum unit, and the gathered data units may be considered to be one data unit to be decoded by the image data decoder 230 in the same encoding mode. For each coding unit determined as described above, information about an encoding mode may be obtained so as to decode the current coding unit.

Also, the image data decoder 230 of the video decoding apparatus 200 of FIG. 9 may perform operations of the quantization parameter determination apparatus 10 and the video decoding apparatus 60 described with reference to FIG. 1.

The image data decoder 230 may determine the transformation unit of the tree structure of each coding unit according to the tree structure, at every maximum coding unit, and may perform the inverse quantization and the inverse transformation of each transformation unit.

The image data decoder 230 determines a default quantization parameter of the current coding unit. The default quantization parameter of the current coding unit may be extracted from a header of the coding unit carrying information about the current coding unit.

The image data decoder 230 may adjust the quantization parameter according to the size of the transformation unit. The image data decoder 230 may reduce the quantization parameter of the transformation unit that is greater than a predetermined size to be less than the default quantization parameter. The image data decoder 230 may increase the quantization parameter of the transformation unit that is less than the predetermined size to be greater than the default quantization parameter.

In particular, the image data decoder 230 may increase a reduction amount of the quantization parameter in proportion to an increasing amount of the transformation unit size. Similarly, the increasing amount of the quantization parameter may increase in proportion to the reduction amount of the transformation unit size.

As another example, the image data decoder 230 may adjust the size of the transformation unit according to the transformation depth of the transformation units. The image data decoder 230 may reduce the quantization parameter of the transformation unit having a transformation depth that is lower than a predetermined depth, to be less than the default quantization parameter. The image data decoder 230 may increase the quantization parameter of the transformation unit having a transformation depth that is higher than a predetermined depth, to be greater than the default quantization parameter.

In this case, the image data decoder 230 may increase the reduction amount of the quantization parameter in proportion to the reduction amount of the transformation depth. Similarly, the image data decoder 230 may increase the increase amount of the quantization parameter in proportion to the increase amount of the transformation depth.

The image data decoder 230 may restore the transformation coefficients by performing the inverse quantization of the quantized transformation coefficients by using the quantization parameter determined according to the size of the transformation unit or the transformation depth.

Information about the reduction amount/increase amount of the quantization parameter corresponding to the size of the transformation unit or the transformation depth may be determined in advance between the video encoding apparatus 100 and the video decoding apparatus 200. However, if the information is not determined in advance, the video decoding apparatus 200 may receive the information about the variation amount of the quantization parameter corresponding to the size of the transformation unit or the transformation depth.

The information about the variation amount of the quantization parameter corresponding to the size of the transformation unit or the transformation depth may be set for every sequence, every picture, or every slice. In this case, the information about the variation amount of the quantization parameter corresponding to the size of the transformation unit or the transformation depth may be extracted from a SPS (Sequence Parameter Set), a picture parameter set (PPS), or a slice header.

The video decoding apparatus 200 may obtain information about at least one coding unit that generates the minimum encoding error when encoding is recursively performed for each maximum coding unit, and may use the information to decode the current picture. In other words, the coding units having the tree structure determined to be the optimum coding units in each maximum coding unit may be decoded.

Accordingly, even if image data has high resolution and a large amount of data, the image data may be efficiently decoded and restored by using a size of a coding unit and an encoding mode, which are adaptively determined according to characteristics of the image data, by using information about an optimum encoding mode received from an encoder.

FIG. 10 is a diagram for describing a concept of coding units according to an embodiment of the present invention.

A size of a coding unit may be expressed in width×height, and may be 64×64, 32×32, 16×16, and 8×8. A coding unit of 64×64 may be split into partitions of 64×64, 64×32, 32×64, or 32×32, and a coding unit of 32×32 may be split into partitions of 32×32, 32×16, 16×32, or 16×16, a coding unit of 16×16 may be split into partitions of 16×16, 16×8, 8×16, or 8×8, and a coding unit of 8×8 may be split into partitions of 8×8, 8×4, 4×8, or 4×4.

In video data 310, a resolution is 1920×1080, a maximum size of a coding unit is 64, and a maximum depth is 2. In video data 320, a resolution is 1920×1080, a maximum size of a coding unit is 64, and a maximum depth is 3. In video data 330, a resolution is 352×288, a maximum size of a coding unit is 16, and a maximum depth is 1. The maximum depth shown in FIG. 10 denotes a total number of splits from a maximum coding unit to a minimum decoding unit.

If a resolution is high or a data amount is large, a maximum size of a coding unit may be large so as to not only increase encoding efficiency but also to accurately reflect characteristics of an image. Accordingly, the maximum size of the coding unit of the video data 310 and 320 having the higher resolution than the video data 330 may be 64.

Since the maximum depth of the video data 310 is 2, coding units 315 of the video data 310 may include a maximum coding unit having a long axis size of 64, and coding units having long axis sizes of 32 and 16 since depths are deepened to two layers by splitting the maximum coding unit twice. Meanwhile, since the maximum depth of the video data 330 is 1, coding units 335 of the video data 330 may include a maximum coding unit having a long axis size of 16, and coding units having a long axis size of 8 since depths are deepened to one layer by splitting the maximum coding unit once.

Since the maximum depth of the video data 320 is 3, coding units 325 of the video data 320 may include a maximum coding unit having a long axis size of 64, and coding units having long axis sizes of 32, 16, and 8 since the depths are deepened to 3 layers by splitting the maximum coding unit three times. As a depth deepens, detailed information may be precisely expressed.

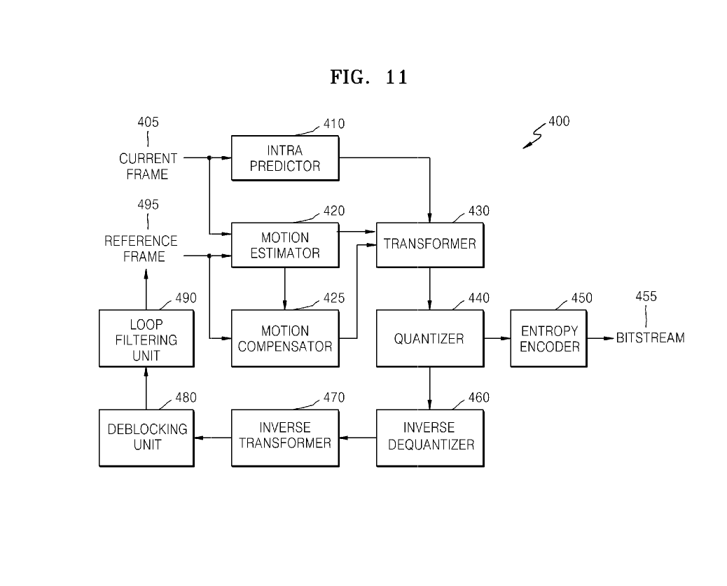

FIG. 11 is a block diagram of an image encoder 400 based on coding units, according to an embodiment of the present invention.

The image encoder 400 performs operations of the coding unit determiner 120 of the video encoding apparatus 100 to encode image data. In other words, an intra predictor 410 performs intra prediction on coding units in an intra mode, from among a current frame 405, and a motion estimator 420 and a motion compensator 425 performs inter prediction and motion compensation on coding units in an inter mode from among the current frame 405 by using the current frame 405, and a reference frame 495.

Data output from the intra predictor 410, the motion estimator 420, and the motion compensator 425 is output as a quantized transformation coefficient through a transformer 430 and a quantizer 440. The quantized transformation coefficient is restored as data in a spatial domain through an inverse quantizer 460 and an inverse transformer 470, and the restored data in the spatial domain is output as the reference frame 495 after being post-processed through a deblocking unit 480 and a loop filtering unit 490. The quantized transformation coefficient may be output as a bitstream 455 through an entropy encoder 450.

In order for the image encoder 400 to be applied in the video encoding apparatus 100, all elements of the image encoder 400, i.e., the intra predictor 410, the motion estimator 420, the motion compensator 425, the transformer 430, the quantizer 440, the entropy encoder 450, the inverse quantizer 460, the inverse transformer 470, the deblocking unit 480, and the loop filtering unit 490 perform operations based on each coding unit from among coding units having a tree structure while considering the maximum depth of each maximum coding unit.

Specifically, the intra predictor 410, the motion estimator 420, and the motion compensator 425 determines partitions and a prediction mode of each coding unit from among the coding units having a tree structure while considering the maximum size and the maximum depth of a current maximum coding unit, and the transformer 430 determines the size of the transformation unit in each coding unit from among the coding units having a tree structure.

In particular, the quantizer 440 and the inverse quantizer 460 may adjust the quantization parameter according to the size of the transformation units or the transformation depth, based on the default quantization parameter of the current coding unit.

The quantization parameter of the transformation unit that is greater than a predetermined size may be reduced less than the default quantization parameter. The quantization parameter of the transformation unit that is less than the predetermined size may be increased greater than the default quantization parameter. In particular, the reduction amount of the quantization parameter is increased in proportion to the increase amount of the transformation unit size, and the increase amount of the quantization parameter may be increased in proportion to the reduction amount of the transformation unit size.

As another example, the quantization parameter of the transformation unit having a transformation depth that is lower than a predetermined depth may be reduced less than the default quantization parameter. The quantization parameter of the transformation unit having a transformation depth that is higher than a predetermined depth may be increased greater than the default quantization parameter. In this case, the reduction amount of the quantization parameter may be increased in proportion to the reduction amount of the transformation depth, and the increase amount of the quantization parameter may be increased in proportion to the increase amount of the transformation depth.

The quantizer 440 may perform the quantization of the transformation coefficients of the transformation units by using the quantization parameter determined according to the size of the transformation unit or the transformation depth so as to generate quantized transformation coefficients. The inverse quantizer 460 may restore the transformation coefficients by performing the inverse quantization of the quantized transformation coefficients by using the quantization parameter determined according to the size of the transformation unit or the transformation depth.

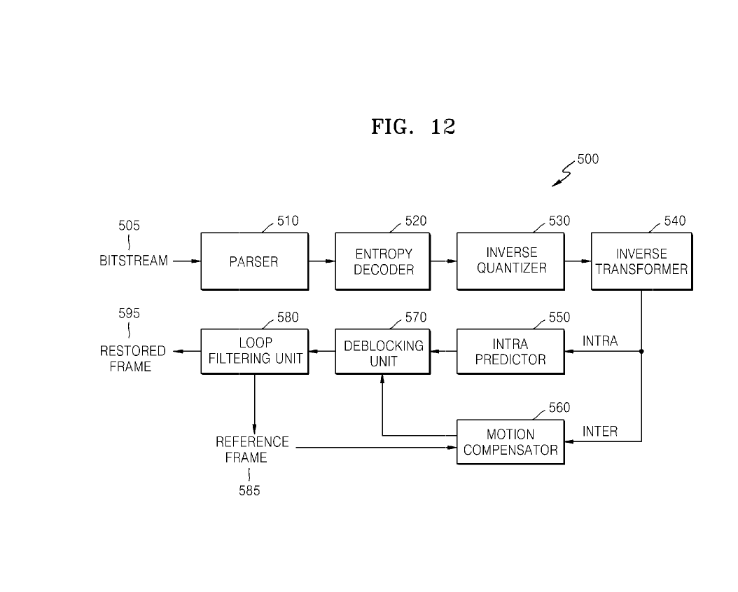

FIG. 12 is a block diagram of an image decoder 500 based on coding units, according to an embodiment of the present invention.

A parser 510 parses encoded image data to be decoded and information about encoding required for decoding from a bitstream 505. The encoded image data is output as inverse quantized data through an entropy decoder 520 and an inverse quantizer 530, and the inverse quantized data is restored to image data in a spatial domain through an inverse transformer 540.

An intra predictor 550 performs intra prediction on coding units in an intra mode with respect to the image data in the spatial domain, and a motion compensator 560 performs motion compensation on coding units in an inter mode by using a reference frame 585.

The image data in the spatial domain, which passed through the intra predictor 550 and the motion compensator 560, may be output as a restored frame 595 after being post-processed through a deblocking unit 570 and a loop filtering unit 580. Also, the image data that is post-processed through the deblocking unit 570 and the loop filtering unit 580 may be output as the reference frame 585.

In order to decode the image data in the image data decoder 230 of the video decoding apparatus 200, the image decoder 500 may perform operations that are performed after the parser 510 performs an operation.

In order for the image decoder 500 to be applied in the video decoding apparatus 200, all elements of the image decoder 500, i.e., the parser 510, the entropy decoder 520, the inverse quantizer 530, the inverse transformer 540, the intra predictor 550, the motion compensator 560, the deblocking unit 570, and the loop filtering unit 580 perform operations based on coding units having a tree structure for each maximum coding unit.

Specifically, the intra predictor 550 and the motion compensator 560 perform operations based on partitions and a prediction mode for each of the coding units having a tree structure, and the inverse transformer 540 perform operations based on a size of a transformation unit for each coding unit.

Also, the inverse quantizer 530 may adjust the quantization parameter according to the size of the transformation units or the transformation depth, based on the default quantization parameter of the current coding unit.

The quantization parameter of the transformation unit that is greater than a predetermined size may be reduced less than the default quantization parameter. The quantization parameter of the transformation unit that is less than the predetermined size may be increased greater than the default quantization parameter. In particular, the reduction amount of the quantization parameter is increased in proportion to the increase amount of the transformation unit size, and the increase amount of the quantization parameter may be increased in proportion to the reduction amount of the transformation unit size.

As another example, the quantization parameter of the transformation unit having a transformation depth that is lower than a predetermined depth may be reduced less than the default quantization parameter. The quantization parameter of the transformation unit having a transformation depth that is higher than a predetermined depth may be increased greater than the default quantization parameter. In this case, the reduction amount of the quantization parameter may be increased in proportion to the reduction amount of the transformation depth, and the increase amount of the quantization parameter may be increased in proportion to the increase amount of the transformation depth.

The inverse quantizer 530 may restore the transformation coefficients by performing the inverse quantization of the quantized transformation coefficients by using the quantization parameter determined according to the size of the transformation unit or the transformation depth.

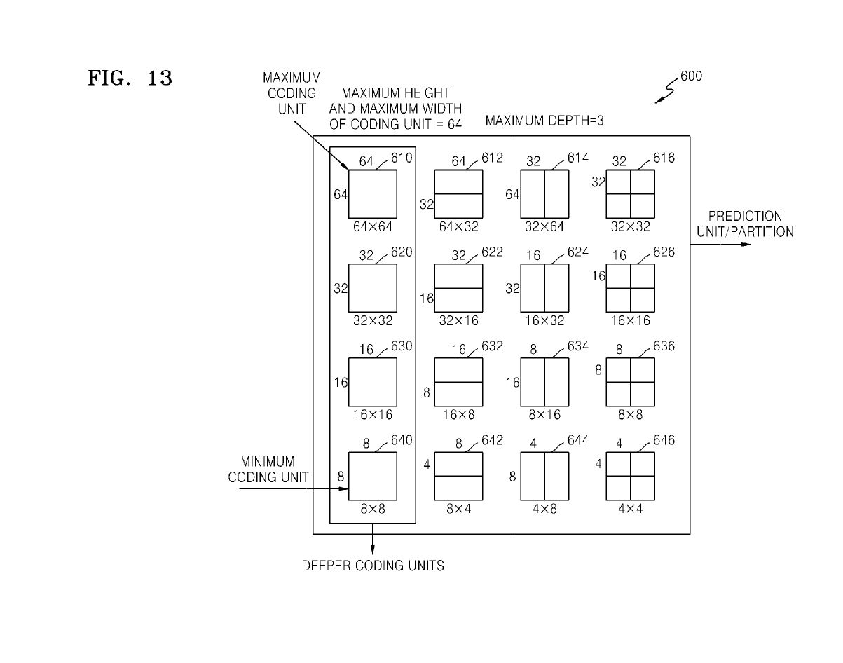

FIG. 13 is a diagram illustrating deeper coding units according to depths, and partitions, according to an embodiment of the present invention.

The video encoding apparatus 100 and the video decoding apparatus 200 use hierarchical coding units so as to consider characteristics of an image. A maximum height, a maximum width, and a maximum depth of coding units may be adaptively determined according to the characteristics of the image, or may be differently set by a user. Sizes of deeper coding units according to depths may be determined according to the predetermined maximum size of the coding unit.

In a hierarchical structure 600 of coding units, according to an embodiment of the present invention, the maximum height and the maximum width of the coding units are each 64, and the maximum depth is 4. In this case, the maximum depth refers to a total number of times the coding unit is split from the maximum coding unit to the minimum coding unit. Since a depth deepens along a vertical axis of the hierarchical structure 600, a height and a width of the deeper coding unit are each split. Also, a prediction unit and partitions, which are bases for prediction encoding of each deeper coding unit, are shown along a horizontal axis of the hierarchical structure 600.

In other words, a coding unit 610 is a maximum coding unit in the hierarchical structure 600, wherein a depth is 0 and a size, i.e., a height by width, is 64×64. The depth deepens along the vertical axis, and a coding unit 620 having a size of 32×32 and a depth of 1, a coding unit 630 having a size of 16×16 and a depth of 2, and a coding unit 640 having a size of 8×8 and a depth of 3. The coding unit 640 having the size of 8×8 and the depth of 3 is a minimum coding unit.

The prediction unit and the partitions of a coding unit are arranged along the horizontal axis according to each depth. In other words, if the coding unit 610 having the size of 64×64 and the depth of 0 is a prediction unit, the prediction unit may be split into partitions included in the encoding unit 610, i.e. a partition 610 having a size of 64×64, partitions 612 having the size of 64×32, partitions 614 having the size of 32×64, or partitions 616 having the size of 32×32.

Similarly, a prediction unit of the coding unit 620 having the size of 32×32 and the depth of 1 may be split into partitions included in the coding unit 620, i.e. a partition 620 having a size of 32×32, partitions 622 having a size of 32×16, partitions 624 having a size of 16×32, and partitions 626 having a size of 16×16.

Similarly, a prediction unit of the coding unit 630 having the size of 16×16 and the depth of 2 may be split into partitions included in the coding unit 630, i.e. a partition having a size of 16×16 included in the coding unit 630, partitions 632 having a size of 16×8, partitions 634 having a size of 8×16, and partitions 636 having a size of 8×8.

Similarly, a prediction unit of the coding unit 640 having the size of 8×8 and the depth of 3 may be split into partitions included in the coding unit 640, i.e. a partition having a size of 8×8 included in the coding unit 640, partitions 642 having a size of 8×4, partitions 644 having a size of 4×8, and partitions 646 having a size of 4×4.

In order to determine the at least one coded depth of the coding units constituting the maximum coding unit 610, the coding unit determiner 120 of the video encoding apparatus 100 performs encoding for coding units corresponding to each depth included in the maximum coding unit 610.

A number of deeper coding units according to depths including data in the same range and the same size increases as the depth deepens. For example, four coding units corresponding to a depth of 2 are required to cover data that is included in one coding unit corresponding to a depth of 1. Accordingly, in order to compare encoding results of the same data according to depths, the coding unit corresponding to the depth of 1 and four coding units corresponding to the depth of 2 are each encoded.

In order to perform encoding for a current depth from among the depths, a least encoding error may be selected for the current depth by performing encoding for each prediction unit in the coding units corresponding to the current depth, along the horizontal axis of the hierarchical structure 600. Alternatively, the minimum encoding error may be searched for by comparing the least encoding errors according to depths, by performing encoding for each depth as the depth deepens along the vertical axis of the hierarchical structure 600. A depth and a partition having the minimum encoding error in the coding unit 610 may be selected as the coded depth and a partition type of the coding unit 610.

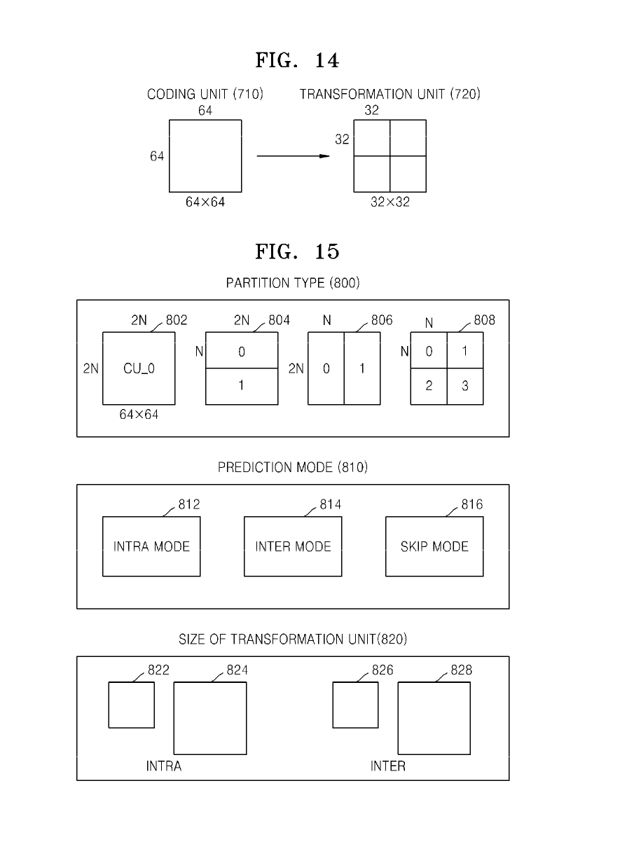

FIG. 14 is a diagram for describing a relationship between a coding unit 710 and transformation units 720, according to an embodiment of the present invention.

The video encoding apparatus 100 or the video decoding apparatus 200 according to the embodiments of the present invention encodes or decodes an image according to coding units having sizes smaller than or equal to a maximum coding unit for each maximum coding unit. Sizes of transformation units for transformation during encoding may be selected based on data units that are not larger than a corresponding coding unit.

For example, in the video encoding apparatus 100 or 200, if a size of the coding unit 710 is 64×64, transformation may be performed by using the transformation units 720 having a size of 32×32.

Also, data of the coding unit 710 having the size of 64×64 may be encoded by performing the transformation on each of the transformation units having the size of 32×32, 16×16, 8×8, and 4×4, which are smaller than 64×64, and then a transformation unit having the least coding error may be selected.

FIG. 15 is a diagram for describing encoding information of coding units corresponding to a coded depth, according to an embodiment of the present invention.

The output unit 130 of the video encoding apparatus 100 may encode and transmit information 800 about a partition type, information 810 about a prediction mode, and information 820 about a size of a transformation unit for each coding unit corresponding to a coded depth, as information about an encoding mode.

The information 800 about the partition type indicates information about a shape of a partition obtained by splitting a prediction unit of a current coding unit, wherein the partition is a data unit for prediction encoding the current coding unit. For example, a current coding unit CU_{—}0 having a size of 2N×2N may be split into any one of a partition 802 having a size of 2N×2N, a partition 804 having a size of 2N×N, a partition 806 having a size of N×2N, and a partition 808 having a size of N×N. Here, the information 800 about a partition type is set to indicate one of the partition 804 having a size of 2N×N, the partition 806 having a size of N×2N, and the partition 808 having a size of N×N.

The information 810 indicates a prediction mode of each partition. For example, the information 810 may indicate a mode of prediction encoding performed on a partition indicated by the information 800, i.e., an intra mode 812, an inter mode 814, or a skip mode 816.

The information 820 indicates a transformation unit to be based on when transformation is performed on a current coding unit. For example, the transformation unit may be a first intra transformation unit 822, a second intra transformation unit 824, a first inter transformation unit 826, or a second inter transformation unit 828.

The image data and encoding information extractor 220 of the video decoding apparatus 200 may extract and use the information 800, 810, and 820 for decoding, according to each deeper coding unit.

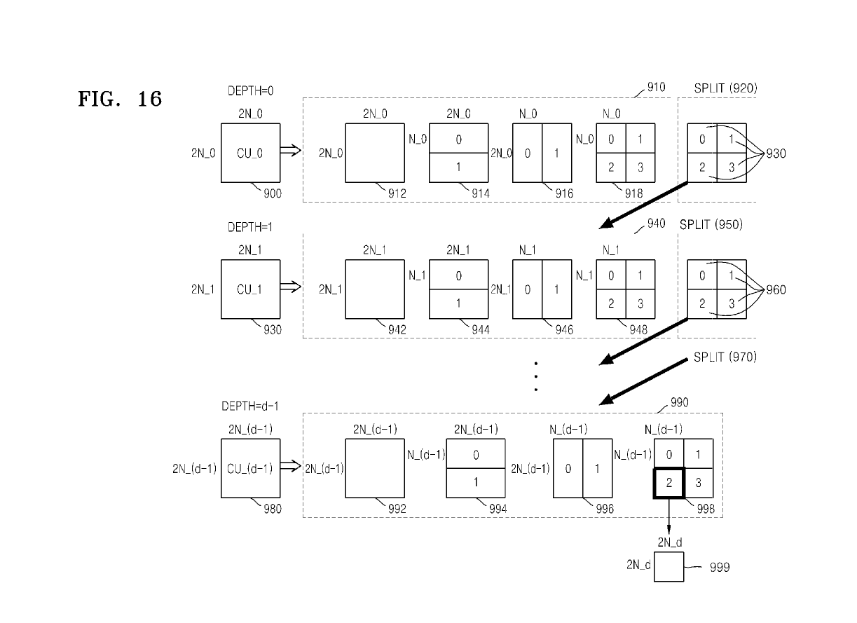

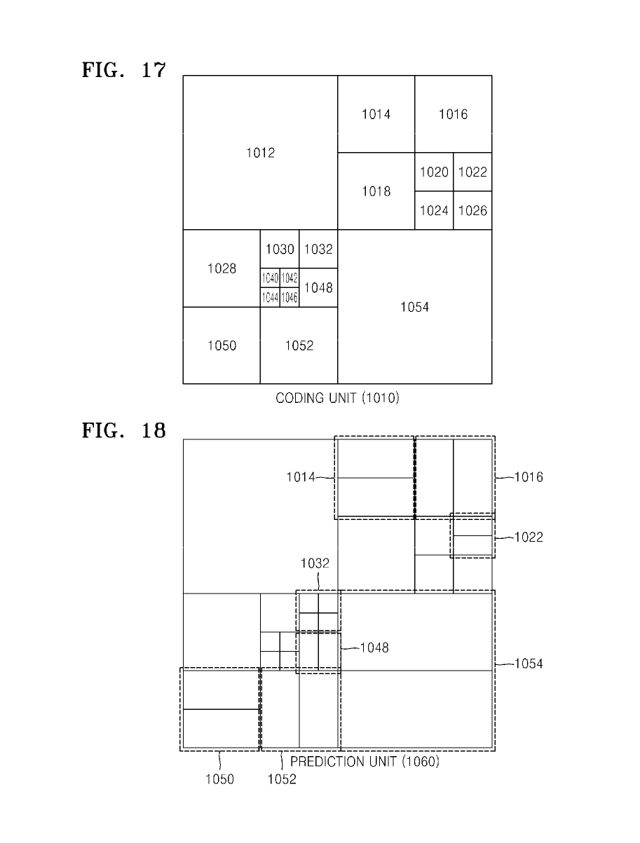

FIG. 16 is a diagram of deeper coding units according to depths, according to an embodiment of the present invention.

Split information may be used to indicate a change of a depth. The spilt information indicates whether a coding unit of a current depth is split into coding units of a lower depth.

A prediction unit 910 for prediction encoding a coding unit 900 having a depth of 0 and a size of 2N_{—}0×2N_{—}0 may include partitions of a partition type 912 having a size of 2N_{—}0×2N_{—}0, a partition type 914 having a size of 2N_{—}0×N_{—}0, a partition type 916 having a size of N_{—}0×2N_{—}0, and a partition type 918 having a size of N_{—}0×N_{—}0. FIG. 16 only illustrates the partition types 912 through 918 which are obtained by symmetrically splitting the prediction unit 910, but a partition type is not limited thereto, and the partitions of the prediction unit 910 may include asymmetrical partitions, partitions having a predetermined shape, and partitions having a geometrical shape.

Prediction encoding is repeatedly performed on one partition having a size of 2N_{—}0×2N_{—}0, two partitions having a size of 2N_{—}0×N_{—}0, two partitions having a size of N_{—}0×2N_{—}0, and four partitions having a size of N_{—}0×N_{—}0, according to each partition type. The prediction encoding in an intra mode and an inter mode may be performed on the partitions having the sizes of 2N_{—}0×2N_{—}0, N_{—}0×2N_{—}0, 2N_{—}0×N_{—}0, and N_{—}0×N_{—}0. The prediction encoding in a skip mode is performed only on the partition having the size of 2N_{—}0×2N_{—}0.

If an encoding error is smallest in one of the partition types 912 through 918 having the sizes of 2N_{—}0×2N_{—}0, N_{—}0×2N_{—}0, 2N_{—}0×N_{—}0, and N_{—}0×N_{—}0, the prediction unit 910 may not be split into a lower depth.

If the encoding error is the smallest in the partition type 918 having the size of N_{—}0×N_{—}0, a depth is changed from 0 to 1 to split the partition type 918 in operation 920, and encoding is repeatedly performed on coding units 930 having a depth of 2 and a size of N_{—}0×N_{—}0 to search for a minimum encoding error.

A prediction unit 940 for prediction encoding the coding unit 930 having a depth of 1 and a size of 2N_{—}1×2N_{—}1 (=N_{—}0×N_{—}0) may include partitions of a partition type 942 having a size of 2N_{—}1×2N_{—}1, a partition type 944 having a size of 2N_{—}1×N_{—}1, a partition type 946 having a size of N_{—}1×2N_{—}1, and a partition type 948 having a size of N_{—}1×N_{—}1.

If an encoding error is the smallest in the partition type 948, a depth is changed from 1 to 2 to split the partition type 948 in operation 950, and encoding is repeatedly performed on coding units 960, which have a depth of 2 and a size of N_{—}2×N_{—}2 to search for a minimum encoding error.

When a maximum depth is d, split operation according to each depth may be performed up to when a depth becomes d−1, and split information may be encoded as up to when a depth is one of 0 to d−2. In other words, when encoding is performed up to when the depth is d−1 after a coding unit corresponding to a depth of d−2 is split in operation 970, a prediction unit 990 for prediction encoding a coding unit 980 having a depth of d−1 and a size of 2N_(d−1)×2N_(d−1) may include partitions of a partition type 992 having a size of 2N_(d−1)×2N_(d−1), a partition type 994 having a size of 2N_(d−1)×N_(d−1), a partition type 996 having a size of N_(d−1)×2N_(d−1), and a partition type 998 having a size of N_(d−1)×N_(d−1).

Prediction encoding may be repeatedly performed on one partition having a size of 2N_(d−1)×2N_(d−1), two partitions having a size of 2N_(d−1)×N_(d−1), two partitions having a size of N_(d−1)×2N_(d−1), four partitions having a size of N_(d−1)×N_(d−1) from among the partition types 992 through 998 to search for a partition type having a minimum encoding error.

Even when the partition type 998 has the minimum encoding error, since a maximum depth is d, a coding unit CU_(d−1) having a depth of d−1 is no longer split to a lower depth, and a coded depth for the coding units constituting a current maximum coding unit 900 is determined to be d−1 and a partition type of the current maximum coding unit 900 may be determined to be N_(d−1)×N_(d−1). Also, since the maximum depth is d and a minimum coding unit 980 having a lowermost depth of d−1 is no longer split to a lower depth, split information for the minimum coding unit 980 is not set.

A data unit 999 may be a ‘minimum unit’ for the current maximum coding unit. A minimum unit according to an embodiment of the present invention may be a rectangular data unit obtained by splitting a minimum coding unit 980 by 4. By performing the encoding repeatedly, the video encoding apparatus 100 may select a depth having the least encoding error by comparing encoding errors according to depths of the coding unit 900 to determine a coded depth, and set a corresponding partition type and a prediction mode as an encoding mode of the coded depth.

As such, the minimum encoding errors according to depths are compared in all of the depths of 1 through d, and a depth having the least encoding error may be determined as a coded depth. The coded depth, the partition type of the prediction unit, and the prediction mode may be encoded and transmitted as information about an encoding mode. Also, since a coding unit is split from a depth of 0 to a coded depth, only split information of the coded depth is set to 0, and split information of depths excluding the coded depth is set to 1.

The image data and encoding information extractor 220 of the video decoding apparatus 200 may extract and use the information about the coded depth and the prediction unit of the coding unit 900 to decode the partition 912. The video decoding apparatus 200 may determine a depth, in which split information is 0, as a coded depth by using split information according to depths, and use information about an encoding mode of the corresponding depth for decoding.

FIGS. 17 through 20 are diagrams for describing a relationship between coding units 1010, prediction units 1060, and transformation units 1070, according to an embodiment of the present invention.

The coding units 1010 are coding units having a tree structure, corresponding to coded depths determined by the video encoding apparatus 100, in a maximum coding unit. The prediction units 1060 are partitions of prediction units of each of the coding units 1010, and the transformation units 1070 are transformation units of each of the coding units 1010.

When a depth of a maximum coding unit is 0 in the coding units 1010, depths of coding units 1012 and 1054 are 1, depths of coding units 1014, 1016, 1018, 1028, 1050, and 1052 are 2, depths of coding units 1020, 1022, 1024, 1026, 1030, 1032, and 1048 are 3, and depths of coding units 1040, 1042, 1044, and 1046 are 4.

In the prediction units 1060, some encoding units 1014, 1016, 1022, 1032, 1048, 1050, 1052, and 1054 are obtained by splitting the coding units in the encoding units 1010. In other words, partition types in the coding units 1014, 1022, 1050, and 1054 have a size of 2N×N, partition types in the coding units 1016, 1048, and 1052 have a size of N×2N, and a partition type of the coding unit 1032 has a size of N×N. Prediction units and partitions of the coding units 1010 are smaller than or equal to each coding unit.

Transformation or inverse transformation is performed on image data of the coding unit 1052 in the transformation units 1070 in a data unit that is smaller than the coding unit 1052. Also, the coding units 1014, 1016, 1022, 1032, 1048, 1050, and 1052 in the transformation units 1070 are different from those in the prediction units 1060 in terms of sizes and shapes. In other words, the video encoding and decoding apparatuses 100 and 200 may perform intra prediction, motion prediction, motion compensation, transformation, and inverse transformation individually on a data unit in the same coding unit.

Accordingly, encoding is recursively performed on each of coding units having a hierarchical structure in each region of a maximum coding unit to determine an optimum coding unit, and thus coding units having a recursive tree structure may be obtained. Encoding information may include split information about a coding unit, information about a partition type, information about a prediction mode, and information about a size of a transformation unit. Table 1 shows the encoding information that may be set by the video encoding and decoding apparatuses 100 and 200.

TABLE 1

| Split Information 0 | | | | | |
|---|---|---|---|---|---|
| (Encoding on Coding Unit having Size | | | | | |
| of 2N × 2N and Current Depth of d) | | | | | Split |
| Prediction | | | Size of | | Informa- |
| Mode | Partition Type | | Transformation Unit | | tion 1 |
| Intra | Sym- | Asym- | Split | Split | Repeatedly |
| Inter | metrical | metrical | Informa- | Informa- | Encode |
| Skip | Partition | Partition | tion 0 of | tion 1 of | Coding |
| (Only | Type | Type | Transfor- | Transfor- | Units |
| 2N × 2N) | | | mation Unit | mation Unit | having |
| | 2N × 2N | 2N × nU | 2N × 2N | N × N | Lower |
| | 2N × N | 2N × nD | | (Symmetrical | Depth of |
| | N × 2N | nL × 2N | | Type) | d + 1 |
| | N × N | nR × 2N | | N/2 × N/2 | |
| | | | | (Asymmetrical | |
| | | | | Type) | |

The output unit 130 of the video encoding apparatus 100 may output the encoding information about the coding units having a tree structure, and the image data and encoding information extractor 220 of the video decoding apparatus 200 may extract the encoding information about the coding units having a tree structure from a received bitstream.

Split information indicates whether a current coding unit is split into coding units of a lower depth. If split information of a current depth d is 0, a depth, in which a current coding unit is no longer split into a lower depth, is a coded depth, and thus information about a partition type, prediction mode, and a size of a transformation unit may be defined for the coded depth. If the current coding unit is further split according to the split information, encoding is independently performed on four split coding units of a lower depth.

A prediction mode may be one of an intra mode, an inter mode, and a skip mode. The intra mode and the inter mode may be defined in all partition types, and the skip mode is defined only in a partition type having a size of 2N×2N.

The information about the partition type may indicate symmetrical partition types having sizes of 2N×2N, 2N×N, N×2N, and N×N, which are obtained by symmetrically splitting a height or a width of a prediction unit, and asymmetrical partition types having sizes of 2N×nU, 2N×nD, nL×2N, and nR×2N, which are obtained by asymmetrically splitting the height or width of the prediction unit. The asymmetrical partition types having the sizes of 2N×nU and 2N×nD may be respectively obtained by splitting the height of the prediction unit in 1:3 and 3:1, and the asymmetrical partition types having the sizes of nL×2N and nR×2N may be respectively obtained by splitting the width of the prediction unit in 1:3 and 3:1.

The size of the transformation unit may be set to be two types in the intra mode and two types in the inter mode. In other words, if split information of the transformation unit is 0, the size of the transformation unit may be 2N×2N, which is the size of the current coding unit. If split information of the transformation unit is 1, the transformation units may be obtained by splitting the current coding unit. Also, if a partition type of the current coding unit having the size of 2N×2N is a symmetrical partition type, a size of a transformation unit may be N×N, and if the partition type of the current coding unit is an asymmetrical partition type, the size of the transformation unit may be N/2×N/2.

The encoding information about coding units having a tree structure may include at least one of a coding unit corresponding to a coded depth, a prediction unit, and a minimum unit. The coding unit corresponding to the coded depth may include at least one of a prediction unit and a minimum unit containing the same encoding information.

Accordingly, it is determined whether adjacent data units are included in the same coding unit corresponding to the coded depth by comparing encoding information of the adjacent data units. Also, a corresponding coding unit corresponding to a coded depth is determined by using encoding information of a data unit, and thus a distribution of coded depths in a maximum coding unit may be determined.

Accordingly, if a current coding unit is predicted based on encoding information of adjacent data units, encoding information of data units in deeper coding units adjacent to the current coding unit may be directly referred to and used.

Alternatively, if a current coding unit is predicted based on encoding information of adjacent data units, data units adjacent to the current coding unit are searched using encoded information of the data units, and the searched adjacent coding units may be referred to for predicting the current coding unit.

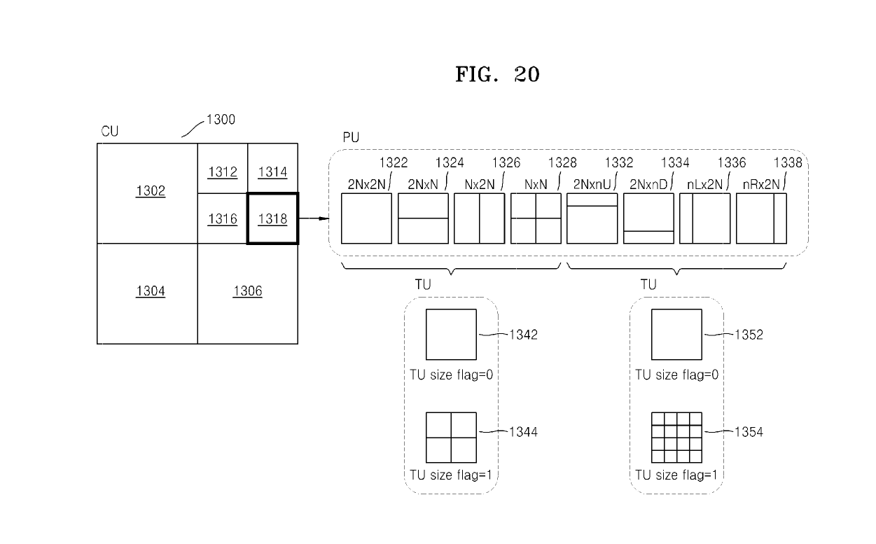

FIG. 20 is a diagram for describing a relationship between a coding unit, a prediction unit or a partition, and a transformation unit, according to encoding mode information of Table 1.

A maximum coding unit 1300 includes coding units 1302, 1304, 1306, 1312, 1314, 1316, and 1318 of coded depths. Here, since the coding unit 1318 is a coding unit of a coded depth, split information may be set to 0. Information about a partition type of the coding unit 1318 having a size of 2N×2N may be set to be one of a partition type 1322 having a size of 2N×2N, a partition type 1324 having a size of 2N×N, a partition type 1326 having a size of N×2N, a partition type 1328 having a size of N×N, a partition type 1332 having a size of 2N×nU, a partition type 1334 having a size of 2N×nD, a partition type 1336 having a size of nL×2N, and a partition type 1338 having a size of nR×2N.

Split information (TU (Transformation Unit)size flag) of a transformation unit is a type of a transformation index. The size of the transformation unit corresponding to the transformation index may be changed according to a prediction unit type or partition type of the coding unit.

For example, when the partition type is set to be symmetrical, i.e. the partition type 1322, 1324, 1326, or 1328, a transformation unit 1342 having a size of 2N×2N is set if split information (TU size flag) of a transformation unit is 0, and a transformation unit 1344 having a size of N×N is set if a TU size flag is 1.

When the partition type is set to be asymmetrical, i.e., the partition type 1332, 1334, 1336, or 1338, a transformation unit 1352 having a size of 2N×2N is set if a TU size flag is 0, and a transformation unit 1354 having a size of N/2×N/2 is set if a TU size flag is 1.

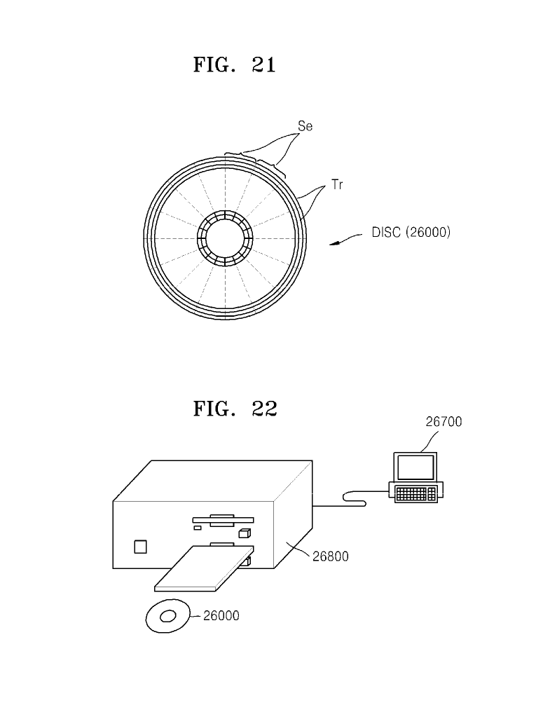

Referring to FIG. 21, the TU size flag is a flag having a value of 0 or 1, but the TU size flag is not limited to 1 bit, and a transformation unit may be hierarchically split having a tree structure while the TU size flag increases from 0. Split information (TU size flag) of a transformation unit may be an example of a transformation index.

In this case, the size of a transformation unit that has been actually used may be expressed by using a TU size flag of a transformation unit, according to an embodiment of the present invention, together with a maximum size and minimum size of the transformation unit. According to an embodiment of the present invention, the video encoding apparatus 100 is capable of encoding maximum transformation unit size information, minimum transformation unit size information, and a maximum TU size flag. The result of encoding the maximum transformation unit size information, the minimum transformation unit size information, and the maximum TU size flag may be inserted into an SPS. According to an embodiment of the present invention, the video decoding apparatus 200 may decode video by using the maximum transformation unit size information, the minimum transformation unit size information, and the maximum TU size flag.

For example, (a) if the size of a current coding unit is 64×64 and a maximum transformation unit size is 32×32, (a−1) then the size of a transformation unit may be 32×32 when a TU size flag is 0, (a−2) may be 16×16 when the TU size flag is 1, and (a−3) may be 8×8 when the TU size flag is 2.

As another example, (b) if the size of the current coding unit is 32×32 and a minimum transformation unit size is 32×32, (b−1) then the size of the transformation unit may be 32×32 when the TU size flag is 0. Here, the TU size flag cannot be set to a value other than 0, since the size of the transformation unit cannot be less than 32×32.

As another example, (c) if the size of the current coding unit is 64×64 and a maximum TU size flag is 1, then the TU size flag may be 0 or 1. Here, the TU size flag cannot be set to a value other than 0 or 1.

Thus, if it is defined that the maximum TU size flag is ‘MaxTransformSizeIndex’, a minimum transformation unit size is ‘MinTransformSize’, and a transformation unit size is ‘RootTuSize’ when the TU size flag is 0, then a current minimum transformation unit size ‘CurrMinTuSize’ that can be determined in a current coding unit, may be defined by Equation (1):

CurrMinTuSize=max(MinTransformSize,RootTuSize/(2̂MaxTransformSizeIndex)) (1)

Compared to the current minimum transformation unit size ‘CurrMinTuSize’ that can be determined in the current coding unit, a transformation unit size ‘RootTuSize’ when the TU size flag is 0 may denote a maximum transformation unit size that can be selected in the system. In Equation (1), ‘RootTuSize/(2̂MaxTransformSizeIndex)’ denotes a transformation unit size when the transformation unit size ‘RootTuSize’, when the TU size flag is 0, is split a number of times corresponding to the maximum TU size flag, and ‘MinTransformSize’ denotes a minimum transformation size. Thus, a smaller value from among ‘RootTuSize/(2̂MaxTransformSizeIndex)’ and ‘MinTransformSize’ may be the current minimum transformation unit size ‘CurrMinTuSize’ that can be determined in the current coding unit.

According to an embodiment of the present invention, the maximum transformation unit size RootTuSize may vary according to the type of a prediction mode.

For example, if a current prediction mode is an inter mode, then ‘RootTuSize’ may be determined by using Equation (2) below. In Equation (2), ‘MaxTransformSize’ denotes a maximum transformation unit size, and ‘PUSize’ denotes a current prediction unit size.

RootTuSize=min(MaxTransformSize,PUSize) (2)

That is, if the current prediction mode is the inter mode, the transformation unit size ‘RootTuSize’, when the TU size flag is 0, may be a smaller value from among the maximum transformation unit size and the current prediction unit size.

If a prediction mode of a current partition unit is an intra mode, ‘RootTuSize’ may be determined by using Equation (3) below. In Equation (3), ‘PartitionSize’ denotes the size of the current partition unit.

RootTuSize=min(MaxTransformSize,PartitionSize) (3)

That is, if the current prediction mode is the intra mode, the transformation unit size ‘RootTuSize’ when the TU size flag is 0 may be a smaller value from among the maximum transformation unit size and the size of the current partition unit.

However, the current maximum transformation unit size ‘RootTuSize’ that varies according to the type of a prediction mode in a partition unit is just an example and the present invention is not limited thereto.

According to the video encoding method based on coding units having a tree structure as described with reference to FIGS. 8 through 20, image data of a spatial region is encoded for each coding unit of a tree structure. According to the video decoding method based on coding units having a tree structure, decoding is performed for each maximum coding unit to restore image data of a spatial region. Thus, a picture and a video that is a picture sequence may be restored. The restored video may be reproduced by a reproducing apparatus, stored in a storage medium, or transmitted through a network.

The embodiments of the present invention may be written as computer programs and may be implemented in general-use digital computers that execute the programs using a computer readable recording medium. Examples of the computer readable recording medium include magnetic storage media (e.g., ROM, floppy disks, hard disks, etc.) and optical recording media (e.g., CD-ROMs, or DVDs).

For convenience of description, a video encoding method according to the multi-view video prediction method, the multi-view video prediction restoring method, or the multi-view video encoding method, which has been described with reference to FIGS. 1 through 21, will be collectively referred to as a ‘video encoding method according to the present invention’. In addition, the video decoding method according to the multi-view video prediction restoring method or the multi-view video decoding method, which has been described with reference to FIGS. 1 through 21, will be referred to as a ‘video decoding method according to the present invention’.

A video encoding apparatus including the multi-view video prediction apparatus 10, the multi-view video prediction restoring apparatus 20, the video encoding apparatus 100, or the image encoder 400, which has been described with reference to FIGS. 1 through 21, will be referred to as a ‘video encoding apparatus according to the present invention’. In addition, a video decoding apparatus including the multi-view video prediction restoring apparatus 20, the video decoding apparatus 200, or the image decoder 500, which has been descried with reference to FIGS. 1 through 21, will be referred to as a ‘video decoding apparatus according to the present invention’.

A computer readable recording medium storing a program, e.g., a disc 26000, according to an embodiment of the present invention will now be described in detail.

FIG. 21 illustrates a physical structure of a disc 26000 that stores a program, according to an embodiment of the present invention. The disc 26000 which is a storage medium may be a hard drive, a compact disc-read only memory (CD-ROM) disc, a Blu-ray disc, or a digital versatile disc (DVD). The disc 26000 includes a plurality of concentric tracks Tr each being divided into a specific number of sectors Se in a circumferential direction of the disc 26000. In a specific region of the disc 26000, a program that executes a method of predicting multi-view video, a method of prediction restoring multi-view video, a method of encoding multi-view video, and a method of decoding multi-view video as described above may be assigned and stored.

A computer system embodied using a storage medium that stores a program for executing a video encoding method and a video decoding method as described above will now be described with reference to FIG. 22.

FIG. 22 illustrates a disc drive 26800 that records and reads a program by using a disc 26000. A computer system 26700 may store a program that executes at least one of a video encoding method and a video decoding method according to an embodiment of the present invention, in a disc 26000 via the disc drive 26800. To run the program stored in the disc 26000 in the computer system 26700, the program may be read from the disc 26000 and be transmitted to the computer system 26700 by using the disc drive 26800.

The program that executes at least one of a video encoding method and a video decoding method according to an embodiment of the present invention may be stored not only in the disc 26000 illustrated in FIG. 21 or 22 but also in a memory card, a ROM cassette, or a solid state drive (SSD).

A system to which the video encoding method and a video decoding method described above are applied will be described below.

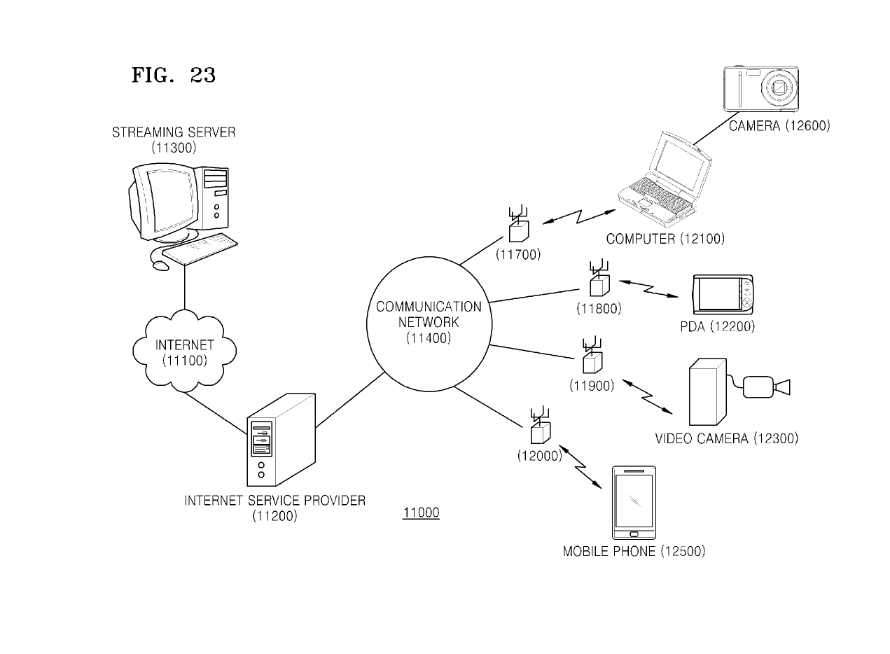

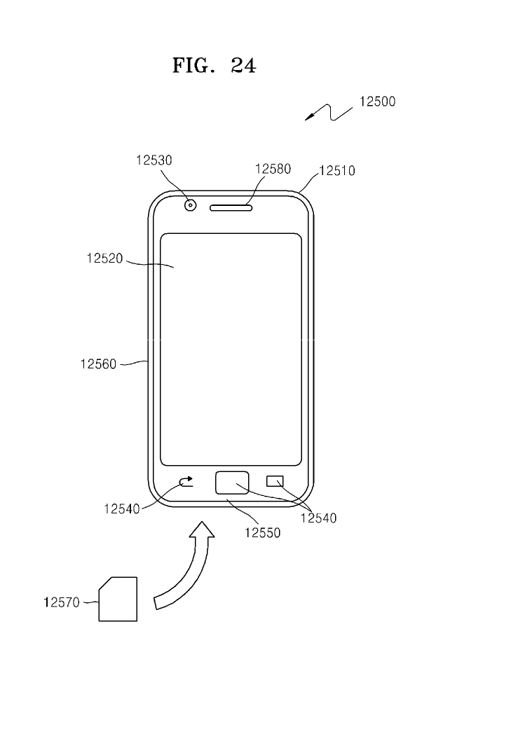

FIG. 23 illustrates an entire structure of a content supply system 11000 that provides content distribution service. A service area of a communication system is divided into predetermined-sized cells, and wireless base stations 11700, 11800, 11900, and 12000 are installed in these cells, respectively.

The content supply system 11000 includes a plurality of independent devices. For example, the plurality of independent devices, such as a computer 12100, a personal digital assistant (PDA) 12200, a video camera 12300, and a mobile phone 12500, are connected to the Internet 11100 via an internet service provider 11200, a communication network 11400, and the wireless base stations 11700, 11800, 11900, and 12000.

However, the content supply system 11000 is not limited to as illustrated in FIG. 24, and devices may be selectively connected thereto. The plurality of independent devices may be directly connected to the communication network 11400, not via the wireless base stations 11700, 11800, 11900, and 12000.

The video camera 12300 is an imaging device, e.g., a digital video camera, which is capable of capturing video images. The mobile phone 12500 may employ at least one communication method from among various protocols, e.g., Personal Digital Communications (PDC), Code Division Multiple Access (CDMA), Wideband-Code Division Multiple Access (W-CDMA), Global System for Mobile Communications (GSM), and Personal Handyphone System (PHS).

The video camera 12300 may be connected to a streaming server 11300 via the wireless base station 11900 and the communication network 11400. The streaming server 11300 allows content received from a user via the video camera 12300 to be streamed via a real-time broadcast. The content received from the video camera 12300 may be encoded using the video camera 12300 or the streaming server 11300. Video data captured by the video camera 12300 may be transmitted to the streaming server 11300 via the computer 12100.

Video data captured by a camera 12600 may also be transmitted to the streaming server 11300 via the computer 12100. The camera 12600 is an imaging device capable of capturing both still images and video images, similar to a digital camera. The video data captured by the camera 12600 may be encoded using the camera 12600 or the computer 12100. Software that performs encoding and decoding video may be stored in a computer readable recording medium, e.g., a CD-ROM disc, a floppy disc, a hard disc drive, an SSD, or a memory card, which may be accessible by the computer 12100.

If video data is captured by a camera built in the mobile phone 12500, the video data may be received from the mobile phone 12500.

The video data may also be encoded by a large scale integrated circuit (LSI) system installed in the video camera 12300, the mobile phone 12500, or the camera 12600.

According to an embodiment of the present invention, the content supply system 11000 may encode content data recorded by a user using the video camera 12300, the camera 12600, the mobile phone 12500, or another imaging device, e.g., content recorded during a concert, and transmit the encoded content data to the streaming server 11300. The streaming server 11300 may transmit the encoded content data in a type of a streaming content to other clients that request the content data.

The clients are devices capable of decoding the encoded content data, e.g., the computer 12100, the PDA 12200, the video camera 12300, or the mobile phone 12500. Thus, the content supply system 11000 allows the clients to receive and reproduce the encoded content data. Also, the content supply system 11000 allows the clients to receive the encoded content data and decode and reproduce the encoded content data in real time, thereby enabling personal broadcasting.

Encoding and decoding operations of the plurality of independent devices included in the content supply system 11000 may be similar to those of a video encoding apparatus and a video decoding apparatus according to an embodiment of the present invention.

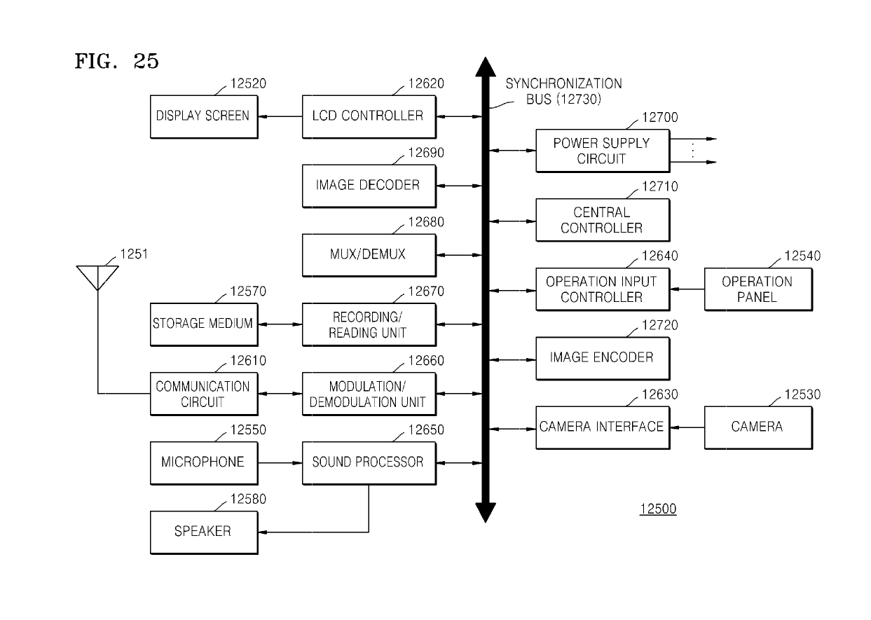

The mobile phone 12500 included in the content supply system 11000 according to an embodiment of the present invention will now be described in greater detail with referring to FIGS. 24 and 25.

FIG. 24 illustrates an external structure of a mobile phone 12500 to which a video encoding method and a video decoding method are applied, according to an embodiment of the present invention. The mobile phone 12500 may be a smart phone, the functions of which are not limited and a large part of the functions of which may be changed or expanded.

The mobile phone 12500 includes an internal antenna 12510 via which a radio-frequency (RF) signal may be exchanged with the wireless base station 12000 of FIG. 24, and includes a display screen 12520 for displaying images captured by a camera 12530 or images that are received via the antenna 12510 and decoded, e.g., a liquid crystal display (LCD) or an organic light-emitting diodes (OLED) screen. The smart phone 12500 includes an operation panel 12540 including a control button and a touch panel. If the display screen 12520 is a touch screen, the operation panel 12540 further includes a touch sensing panel of the display screen 12520. The smart phone 12500 includes a speaker 12580 for outputting voice and sound or another type sound output unit, and a microphone 12550 for inputting voice and sound or another type sound input unit. The smart phone 12500 further includes the camera 12530, such as a charge-coupled device (CCD) camera, to capture video and still images. The smart phone 12500 may further include a storage medium 12570 for storing encoded/decoded data, e.g., video or still images captured by the camera 12530, received via email, or obtained according to various ways; and a slot 12560 via which the storage medium 12570 is loaded into the mobile phone 12500. The storage medium 12570 may be a flash memory, e.g., a secure digital (SD) card or an electrically erasable and programmable read only memory (EEPROM) included in a plastic case.

FIG. 25 illustrates an internal structure of the mobile phone 12500, according to an embodiment of the present invention. To systemically control parts of the mobile phone 12500 including the display screen 12520 and the operation panel 12540, a power supply circuit 12700, an operation input controller 12640, an image encoding unit 12720, a camera interface 12630, an LCD controller 12620, an image decoding unit 12690, a multiplexer/demultiplexer 12680, a recording/reading unit 12670, a modulation/demodulation unit 12660, and a sound processor 12650 are connected to a central controller 12710 via a synchronization bus 12730.

If a user operates a power button and sets from a ‘power off’ state to a power on’ state, the power supply circuit 12700 supplies power to all the parts of the mobile phone 12500 from a battery pack, thereby setting the mobile phone 12500 in an operation mode.

The central controller 12710 includes a central processing unit (CPU), a ROM, and a random access memory (RAM).

While the mobile phone 12500 transmits communication data to the outside, a digital signal is generated in the mobile phone 12500 under control of the central controller. For example, the sound processor 12650 may generate a digital sound signal, the image encoding unit 12720 may generate a digital image signal, and text data of a message may be generated via the operation panel 12540 and the operation input controller 12640. When a digital signal is delivered to the modulation/demodulation unit 12660 under control of the central controller 12710, the modulation/demodulation unit 12660 modulates a frequency band of the digital signal, and a communication circuit 12610 performs digital-to-analog conversion (DAC) and frequency conversion on the frequency band-modulated digital sound signal. A transmission signal output from the communication circuit 12610 may be transmitted to a voice communication base station or the wireless base station 12000 via the antenna 12510.

For example, when the mobile phone 12500 is in a conversation mode, a sound signal obtained via the microphone 12550 is transformed into a digital sound signal by the sound processor 12650, under control of the central controller 12710. The digital sound signal may be transformed into a transformation signal via the modulation/demodulation unit 12660 and the communication circuit 12610, and may be transmitted via the antenna 12510.

When a text message, e.g., email, is transmitted in a data communication mode, text data of the text message is input via the operation panel 12540 and is transmitted to the central controller 12710 via the operation input controller 12640. Under control of the central controller 12710, the text data is transformed into a transmission signal via the modulation/demodulation unit 12660 and the communication circuit 12610 and is transmitted to the wireless base station 12000 via the antenna 12510.

To transmit image data in the data communication mode, image data captured by the camera 12530 is provided to the image encoding unit 12720 via the camera interface 12630. The captured image data may be directly displayed on the display screen 12520 via the camera interface 12630 and the LCD controller 12620.

A structure of the image encoding unit 12720 may correspond to that of the video encoding apparatus 100 described above. The image encoding unit 12720 may transform the image data received from the camera 12530 into compressed and encoded image data according to a video encoding method employed by the video encoding apparatus 100 or the image encoder 400 described above, and then output the encoded image data to the multiplexer/demultiplexer 12680. During a recording operation of the camera 12530, a sound signal obtained by the microphone 12550 of the mobile phone 12500 may be transformed into digital sound data via the sound processor 12650, and the digital sound data may be delivered to the multiplexer/demultiplexer 12680.

The multiplexer/demultiplexer 12680 multiplexes the encoded image data received from the image encoding unit 12720, together with the sound data received from the sound processor 12650. A result of multiplexing the data may be transformed into a transmission signal via the modulation/demodulation unit 12660 and the communication circuit 12610, and may then be transmitted via the antenna 12510.

While the mobile phone 12500 receives communication data from the outside, frequency recovery and ADC are performed on a signal received via the antenna 12510 to transform the signal into a digital signal. The modulation/demodulation unit 12660 modulates a frequency band of the digital signal. The frequency-band modulated digital signal is transmitted to the video decoding unit 12690, the sound processor 12650, or the LCD controller 12620, according to the type of the digital signal.

In the conversation mode, the mobile phone 12500 amplifies a signal received via the antenna 12510, and obtains a digital sound signal by performing frequency conversion and ADC on the amplified signal. A received digital sound signal is transformed into an analog sound signal via the modulation/demodulation unit 12660 and the sound processor 12650, and the analog sound signal is output via the speaker 12580, under control of the central controller 12710.

When in the data communication mode, data of a video file accessed at an Internet website is received, a signal received from wireless base station 12000 via the antenna 12510 is output as multiplexed data via the modulation/demodulation unit 12660, and the multiplexed data is transmitted to the multiplexer/demultiplexer 12680.

To decode the multiplexed data received via the antenna 12510, the multiplexer/demultiplexer 12680 demultiplexes the multiplexed data into an encoded video data stream and an encoded audio data stream. Via the synchronization bus 12730, the encoded video data stream and the encoded audio data stream are provided to the video decoding unit 12690 and the sound processor 12650, respectively.

A structure of the image decoding unit 12690 may correspond to that of the video decoding apparatus 200 described above. The image decoding unit 12690 may decode the encoded video data to obtain restored video data and provide the restored video data to the display screen 12520 via the LCD controller 12620, according to a video decoding method employed by the video decoding apparatus 200 or the image decoder 500 described above.

Thus, the data of the video file accessed at the Internet website may be displayed on the display screen 12520. At the same time, the sound processor 12650 may transform audio data into an analog sound signal, and provide the analog sound signal to the speaker 12580. Thus, audio data contained in the video file accessed at the Internet website may also be reproduced via the speaker 12580.

The mobile phone 12500 or another type of communication terminal may be a transceiving terminal including both a video encoding apparatus and a video decoding apparatus according to an embodiment of the present invention, may be a transceiving terminal including only the video encoding apparatus, or may be a transceiving terminal including only the video decoding apparatus.

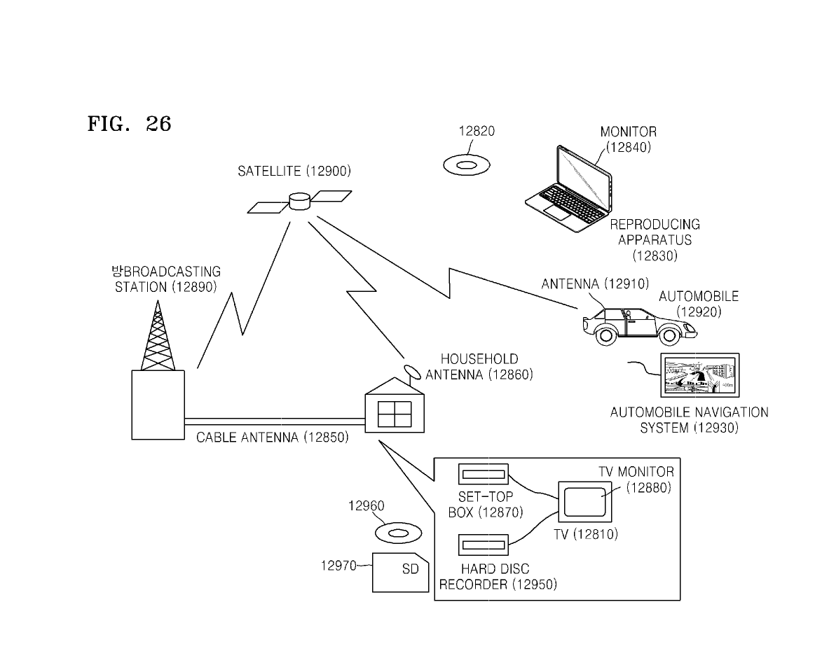

A communication system according to the present invention is not limited to the communication system described above with reference to FIG. 24. For example, FIG. 26 illustrates a digital broadcasting system employing a communication system, according to an embodiment of the present invention. The digital broadcasting system of FIG. 26 may receive a digital broadcast transmitted via a satellite or a terrestrial network by using a video encoding apparatus and a video decoding apparatus according to an embodiment of the present invention.

Specifically, a broadcasting station 12890 transmits a video data stream to a communication satellite or a broadcasting satellite 12900 by using radio waves. The broadcasting satellite 12900 transmits a broadcast signal, and the broadcast signal is transmitted to a satellite broadcast receiver via a household antenna 12860. In every house, an encoded video stream may be decoded and reproduced by a TV receiver 12810, a set-top box 12870, or another device.

When a video decoding apparatus according to an embodiment of the present invention is implemented in a reproducing apparatus 12830, the reproducing apparatus 12830 may parse and decode an encoded video stream recorded on a storage medium 12820, such as a disc or a memory card to restore digital signals. Thus, the restored video signal may be reproduced, for example, on a monitor 12840.

In the set-top box 12870 connected to the antenna 12860 for a satellite/terrestrial broadcast or a cable antenna 12850 for receiving a cable television (TV) broadcast, a video decoding apparatus according to an embodiment of the present invention may be installed. Data output from the set-top box 12870 may also be reproduced on a TV monitor 12880.

As another example, a video decoding apparatus according to an embodiment of the present invention may be installed in the TV receiver 12810 instead of the set-top box 12870.

An automobile 12920 including an appropriate antenna 12910 may receive a signal transmitted from the satellite 12900 or the wireless base station 11700. A decoded video may be reproduced on a display screen of an automobile navigation system 12930 built in the automobile 12920.

A video signal may be encoded by a video encoding apparatus according to an embodiment of the present invention and may then be stored in a storage medium. Specifically, an image signal may be stored in a DVD disc 12960 by a DVD recorder or may be stored in a hard disc by a hard disc recorder 12950. As another example, the video signal may be stored in an SD card 12970. If the hard disc recorder 12950 includes a video decoding apparatus according to an embodiment of the present invention, a video signal recorded on the DVD disc 12960, the SD card 12970, or another storage medium may be reproduced on the TV monitor 12880.

The automobile navigation system 12930 may not include the camera 12530, the camera interface 12630, and the image encoding unit 12720 of FIG. 26. For example, the computer 12100 and the TV receiver 12810 may not be included in the camera 12530, the camera interface 12630, and the image encoding unit 12720 of FIG. 26.

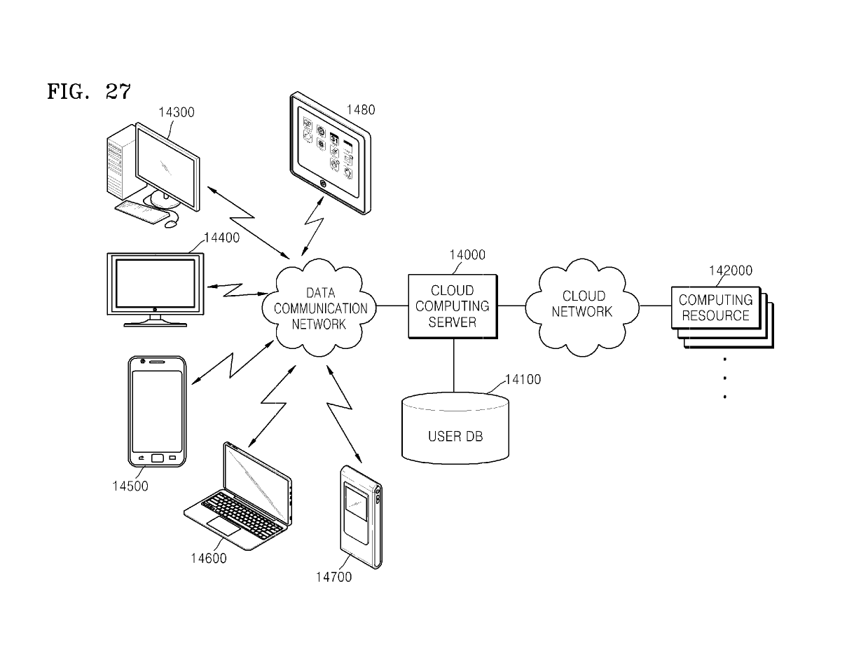

FIG. 27 illustrates a network structure of a cloud computing system using a video encoding apparatus and a video decoding apparatus, according to an embodiment of the present invention.

The cloud computing system may include a cloud computing server 14000, a user database (DB) 14100, a plurality of computing resources 14200, and a user terminal.

The cloud computing system provides an on-demand outsourcing service of the plurality of computing resources 14200 via a data communication network, e.g., the Internet, in response to a request from the user terminal. Under a cloud computing environment, a service provider provides users with desired services by combining computing resources at data centers located at physically different locations by using virtualization technology. A service user does not have to install computing resources, e.g., an application, a storage, an operating system (OS), and security, into his/her own terminal in order to use them, but may select and use desired services from among services in a virtual space generated through the virtualization technology, at a desired point of time.

A user terminal of a specified service user is connected to the cloud computing server 14000 via a data communication network including the Internet and a mobile telecommunication network. User terminals may be provided cloud computing services, and particularly video reproduction services, from the cloud computing server 14000. The user terminals may be various types of electronic devices capable of being connected to the Internet, e.g., a desk-top PC 14300, a smart TV 14400, a smart phone 14500, a notebook computer 14600, a portable multimedia player (PMP) 14700, a tablet PC 14800, and the like.

The cloud computing server 14000 may combine the plurality of computing resources 14200 distributed in a cloud network and provide user terminals with a result of the combining. The plurality of computing resources 14200 may include various data services, and may include data uploaded from user terminals. As described above, the cloud computing server 14000 may provide user terminals with desired services by combining video database distributed in different regions according to the virtualization technology.

User information about users who has subscribed to a cloud computing service is stored in the user DB 14100. The user information may include logging information, addresses, names, and personal credit information of the users. The user information may further include indexes of videos. Here, the indexes may include a list of videos that have already been reproduced, a list of videos that are being reproduced, a pausing point of a video that was being reproduced, and the like.

Information about a video stored in the user DB 14100 may be shared between user devices. For example, when a video service is provided to the notebook computer 14600 in response to a request from the notebook computer 14600, a reproduction history of the video service is stored in the user DB 14100. When a request to reproduce this video service is received from the smart phone 14500, the cloud computing server 14000 searches for and reproduces this video service, based on the user DB 14100. When the smart phone 14500 receives a video data stream from the cloud computing server 14000, a process of reproducing video by decoding the video data stream is similar to an operation of the mobile phone 12500 described above with reference to FIG. 24.

The cloud computing server 14000 may refer to a reproduction history of a desired video service, stored in the user DB 14100. For example, the cloud computing server 14000 receives a request to reproduce a video stored in the user DB 14100, from a user terminal. If this video was being reproduced, then a method of streaming this video, performed by the cloud computing server 14000 may vary according to the request from the user terminal, i.e., according to whether the video will be reproduced, starting from a start thereof or a pausing point thereof. For example, if the user terminal requests to reproduce the video, starting from the start thereof, the cloud computing server 14000 transmits streaming data of the video starting from a first frame thereof to the user terminal. If the user terminal requests to reproduce the video, starting from the pausing point thereof, the cloud computing server 14000 transmits streaming data of the video starting from a frame corresponding to the pausing point, to the user terminal.

In this case, the user terminal may include a video decoding apparatus as described above with reference to FIGS. 1 to 23. As another example, the user terminal may include a video encoding apparatus as described above with reference to FIGS. 1 to 23. Alternatively, the user terminal may include both the video decoding apparatus and the video encoding apparatus as described above with reference to FIGS. 1 to 23.

Various applications of a video encoding method, a video decoding method, a video encoding apparatus, and a video decoding apparatus according to embodiments of the present invention described above with reference to FIGS. 1 to 21 have been described above with reference to FIGS. 21 to 27. However, methods of storing the video encoding method and the video decoding method in a storage medium or methods of implementing the video encoding apparatus and the video decoding apparatus in a device according to various embodiments of the present invention, are not limited to the embodiments described above with reference to FIGS. 21 to 27.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A quantization parameter determination method, the method comprising:
determining transformation units of at least one size included in a coding unit;
determining a default quantization parameter of the coding unit;
reducing a quantization parameter of a transformation unit that is greater than a predetermined size among the transformation units, to be less than the default quantization parameter; and
increasing a quantization parameter of a transformation unit that is less than the predetermined size among the transformation units, to be greater than the default quantization parameter.

2. The method of claim 1, wherein the determining of the transformation units comprises determining transformation units of at least one transformation depth included in the coding unit, when the size of the transformation unit is determined by the level of the corresponding transformation depth, wherein the transformation depth denotes a number of split of the coding unit,
the determining of the default quantization parameter comprises determining the default quantization parameter allocated to a transformation unit of a predetermined depth in the at least one level of transformation depth,
the reducing of the quantization parameter comprises reducing the quantization parameter of the transformation unit of a transformation depth that is lower than the predetermined depth, to be less than the default quantization parameter, and
the increasing of the quantization parameter comprises increasing the quantization parameter of a transformation depth that is higher than the predetermined depth, to be greater than the default quantization parameter.

3. The method of claim 1, wherein the reducing of the quantization parameter comprises reducing the quantization parameter by a difference value of the quantization parameter from the default quantization parameter, and the increasing of the quantization parameter comprises increasing the quantization parameter by a difference value of the quantization value from the default quantization parameter.

4. The method of claim 2, wherein the reducing of the quantization parameter comprises determining a reduction amount of the difference value of the quantization parameter reduced by from the default quantization parameter in proportion to a reduction amount of the current transformation depth of the transformation unit from the predetermined transformation depth, and increasing of the quantization parameter comprises determining an increase amount of the difference value of the quantization parameter increasing by from the default quantization parameter in proportion to an increase amount of the current transformation depth of the transformation unit from the predetermined transformation depth.

5. The method of claim 1, further comprising generating quantized transformation coefficients by performing quantization of the transformation units by using the determined quantization parameters.

6. The method of claim 1, further comprising restoring the transformation coefficients from the quantized transformation coefficients by performing an inverse quantization of the transformation units by using the determined quantization parameter.

7. The method of claim 1, further comprising encoding and transmitting information about the difference value of the quantization parameter increasing or reducing from the default quantization parameter and the default quantization parameter.

8. The method of claim 1, further comprising receiving the information about the difference value of the quantization parameter increasing or reducing by from the default quantization parameter and the default quantization parameter.

9. A quantization parameter determination apparatus, the apparatus comprising:
a transformation unit determiner for determining transformation units of at least one size included in a coding unit; and
a quantization parameter determiner for determining a default quantization parameter of the coding unit, and determining quantization parameters of the transformation unit by reducing a quantization parameter of a transformation unit that is less than a predetermined size to be less than the default quantization parameter, and by increasing the quantization parameter of a transformation unit that is greater than the predetermined size to be greater than the default quantization parameter.

10. The apparatus of claim 9, wherein the transformation unit determiner determines transformation units of at least one transformation depth included in the coding unit, when the size of the transformation unit is determined by the level of the corresponding transformation depth, wherein the transformation depth denotes a number of split of the coding unit,
the quantization parameter determiner determines the default quantization parameter allocated to a transformation unit of a predetermined depth in the at least one level of transformation depth, reduces the quantization parameter of the transformation unit of a transformation depth that is lower than the predetermined depth, to be less than the default quantization parameter, and increases the quantization parameter of a transformation depth that is higher than the predetermined depth, to be greater than the default quantization parameter

11. The apparatus of claim 9, wherein the quantization parameter determiner reduces or increases the quantization parameter by a difference value of the quantization parameter from the default quantization parameter.

12. The apparatus of claim 10, wherein the quantization parameter determiner determines a reduction amount of the difference value of the quantization parameter reduced by from the default quantization parameter in proportion to a reduction amount of the current transformation depth of the transformation unit from the predetermined transformation depth, and determines an increase amount of the difference value of the quantization parameter increasing by from the default quantization parameter in proportion to an increase amount of the current transformation depth of the transformation unit from the predetermined transformation depth.

13. The apparatus of claim 9, further comprising:
a predictor generating prediction data of a prediction unit by performing an intra prediction or a motion prediction of the at least one prediction unit in the current coding unit;
a transformer generating transformation coefficients of the transformation units by transforming the determined transformation units included in the current coding unit that includes the generated prediction data; and
a quantizer generating quantized transformation coefficients by performing quantization of the transformation units by using the determined quantization parameter.

14. The apparatus of claim 9, further comprising:
an inverse quantizer restoring the transformation coefficients from the quantized transformation coefficients by performing an inverse quantization of the transformation units by using the determined quantization parameter;
an inverse transformer restoring the prediction data by performing an inverse transformation of the transformation coefficients; and
a prediction restoring unit for restoring image data of the prediction unit by performing an intra prediction or a motion compensation of the at least one prediction unit in the current coding unit, based on the restored prediction data included in the current coding unit.

15. A computer readable recording medium having recorded thereon a program for executing the quantization parameter determination method of claim 1.
